(19) United States
(12) Patent Application Publication
(10) Pub. No.: US 2024/0265391 A1
(43) Pub. Date: Aug. 8, 2024

(54) NUMERICALLY DELINEATED VALUE TRANSFER

(71) Applicant: Legiteum, Inc., McLean, VA (US)

(72) Inventor: Stephen Richard Thomas, McLean, VA (US)

(21) Appl. No.: 18/431,996

(22) Filed: Feb. 4, 2024

Related U.S. Application Data
(60) Provisional application No. 63/483,861, filed on Feb. 8, 2023.

(51) Int. Cl. G06Q 20/40

(52) U.S. Cl. CPC G06Q 20/401

(57) ABSTRACT

An approach is disclosed for numerically delineated value transfer. An infrastructure for representation of values for the numerically delineated value transfer is provided that minimizes real-time operations to transfer a first value in a first representation of the first value to a second value in a second representation of the second value where the infrastructure supports recovery from operational failures. The infrastructure receives a split or combine operation with a recovery indication and an indication of the first representation. Responsive to receiving the split operation an amount to split is specified and the first value in the first representation is decremented by the amount to split and the amount to split is included in the second representation and for the combine operation the first representation contains the first value to be added to the second value in the second representation.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC § 119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

For purposes of the USPTO extra-statutory requirements, the present application constitutes a utility application related to and claims the benefit of priority from U.S. Provisional Patent Application No. 63/483,61 Feb. 8, 2023.

### STATEMENT REGARDING PRIOR DISCLOSURES BY THE INVENTOR OR A JOINT INVENTOR

The following disclosures are submitted under 35 U.S.C. 102(b)(1)(A): DISCLOSURE: “HayPenny Platform WhitePaper Final” by Steven Thomas, available at https://haypenny.net/whitepaper.html DISCLOSURE: “Haypenny Developer Portal” by Steven Thomas, available at https://haypenny.net/dev.html DISCLOSURE: “Haypenny API Reference” by Steven Thomas, available at https://haypenny.net/apiref.html.

If an Application Data Sheet (ADS) has been filed for this application, it is incorporated by reference herein. Any applications claimed on the ADS for priority under 35 U.S.C. §§ 119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### BACKGROUND

The present invention relates to a computing environment, and more particularly to numerically delineated value transfer.

### SUMMARY

According to an embodiment of the present invention, there is a method that includes a processor and a local storage device accessible by the processor for numerically delineated value transfer. An infrastructure for representation of values for the numerically delineated value transfer is provided that minimizes real-time operations to transfer a first value in a first representation of the first value to a second value in a second representation of the second value where the infrastructure supports recovery from operational failures. The infrastructure receives an operation with a recovery indication and an indication of the first representation and where the operation is one of a split operation and a combine operation. Responsive to receiving the operation, the operation is performed such that for the split operation an amount to split is specified and the first value in the first representation is decremented by the amount to split and the amount to split is included in the second representation and for the combine operation the first representation contains the first value to be added to the second value in the second representation.

According to one embodiment of the invention, there is provided an information handling system including at least one processor and a local storage device accessible by the processor executing instructions implementing steps of the method for numerically delineated value transfer.

According to one embodiment of the invention, there is provided a computing program product executing instructions on at least one processor including a local storage device accessible by the processor having the steps of the method for processor for numerically delineated value transfer.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 shows a diagram depicting a schematic overview of a digital financial transaction system architecture;

FIG. 2 depicts a layering of HayPenny infrastructure;

FIG. 3 depicts a schematic flow of a process Data Table operation;

FIG. 4 depicts a schematic flow of a process registration operation;

FIG. 5 depicts a flowchart of a load balancer selecting a service provider member (SPM);

FIG. 6 depicts a flow of a process that maintains a service provider list.

FIG. 7 shows the steps to select a pool member (SPM) to process an HTTP request;

FIG. 8 provides a schematic view of a block and block processing operations;

FIG. 9 shows the steps taken by a process to split HTTP block request;

FIG. 10 depicts processing a Backend Data Table (DT) Split Data Table Request 1 [modulo block ID, realm ID, transaction ID, amount to subtract];

FIG. 11 depicts processing Backend BT Split Data Table Request 1 [modulo new block ID, realm ID, transaction ID, amount] processing;

FIG. 12 shows the steps taken to process a combine HTTP block request;

FIG. 13 shows the steps taken to delete a block deleteBlock (deleteblockID,remoteIp, transactionID, secret) processed by shard operation;

FIG. 14 depicts the sets to process setBlock 2a (blockID, amount, 0, returnBlock, remoteIp, transactionID, secret) processed by shard operation;

FIG. 15 depicts a createblock 2a process (blockID, amount, 0, returnBlock, remoteIp, transactionID, secret) processed by shard operation;

FIG. 16 depicts logfile background reading and processing;

FIG. 17 depicts recovering process;

FIG. 18 depicts a DBtable description;

FIG. 19 depicts a Realm or coin ID description;

FIG. 20 depicts an offer record description;

FIG. 21 depicts a bid record description;

FIG. 22 depicts a structure of a hash table;

FIG. 23 list some public APIs;

FIG. 24 list some user APIs;

FIG. 25 list some user APIs continued; and

FIG. 26 depicts a schematic view of a processing system wherein the methods of this invention may be implemented.

### DETAILED DESCRIPTION

Currently available approaches to value transfer transactions require some kind of identity (either a real legal entity or a cryptographic identity) for each side of the transaction, which necessarily adds complexity to the model. Financial transactions involving an identity require each side of the transaction to create an identity first. This identity also creates a security risk insofar as it exists as something that can be connected to an individual person or entity.

Creating a digital currency, such as a cryptocurrency, is a long and expensive process only attainable by skilled programmers.

General purpose data systems (e.g., a relational database) also add overhead to the task of executing a simple transaction model like the one described herein because of their generalized model.

Given the deficiencies of the prior art, there is a need for an entirely new kind of transaction engine, which cost-effectively scales to millions of transactions per second with absolute transaction integrity, redundancy, and consistent low latency.

The novel financial transaction method described herein is the simplest form of numerically delineated value transfer—much simpler than other methods such as banking transactions, credit card transactions, or cryptocurrency.

As a new value transfer paradigm, this system may change the way consumers think about transactions as they may now happen anonymously at extremely high speed, be much smaller in value, and be virtually free in price.

The disclosed system allows non-programmers to quickly invent their own digital currency in just a few minutes. This system may also be used by an entity, such as a government, to maintain a single official currency. It may also be used by any application needing a very high scale and low-cost facility to perform financial transactions, such as video games, ads, and so on.

Currently available approaches require far more—ten to a hundred times more—hardware resources to handle than the same number of concurrent requests as the system described herein.

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a digital financial transaction method, a digital financial transaction system, and a digital financial transaction computer program product for use therewith, that enables simple, anonymous, and efficient financial transactions over the Internet. The disclosed system is sometimes referred to herein as “Haypenny.”

The Haypenny system enables the transfer of a symbolic value from one entity to another, defining a core system representation of the symbolic value or an object—called a “block”—which is its identifier, its balance, and its currency identifier. Although variations of the object, such as, size, fields, field sizes may vary, the Haypenny system provides a reference implementation with fixed size fields. Other embodiments of the disclosed concept may have different infrastructure elements, different sized fields, and variations in the underlying semantics of operation. In an embodiment, fields could have varying sizes. In the Haypenny system, a block has two possible application-level modifying operations: split and combine.

An objective of the disclosed system is to allow goods and services to be traded globally using digital currencies every day, many times a day, at a very low—almost unnoticeable—cost per transaction. And the system should be effectively free to hobbyists.

To realize that vision, an entirely new kind of transaction engine needed to be built: one that can cost-effectively scale to millions of transactions per second and do so with absolute transaction integrity, multi-site redundancy, and consistent low latency.

The system described herein achieves the lowest possible cost per transaction in the context of an ultra-high scale system, which is two network operations and two non-volatile storage operations for each transaction side, per data center location (typically three locations, called asynchronously.

Although other approaches and variations may be utilized, in a reference embodiment, there are only two basic operations with a four-tier system model of client, real-time, near-real-time and offline support systems, and the construction of an entirely purpose-built software system having several components built from scratch.

The resulting system has been benchmarked and cost-modeled to show it able to scale to its initial goal of one million peak transactions per second and 100 billion transactions per month for approximately $0.000004 per transaction in total data center fees. This is done in the context of each transaction being written in multiple, geographically dispersed data stores.

This system enables a business model that can be operationally profitable while charging only $0.005 for only a fraction of its executed transactions, and yet one that can be relied upon to store critical financial information.

The system preferably utilizes secure, robust, scalable hardware and networking infrastructure. The system is extremely efficient with respect to hardware resources relative to activity and to the number of users served.

As used herein, the term “Front-end (FE) processors” refers to a pool of systems that unpack and interpret application programming interface (API) calls, perform the calls to Data Table (DT) processors, and return the properly formatted reply to the caller.

“Block” refers to a Haypenny block, which may be represented externally as a string of 22 characters.

A “Data Table processor” is a system that listens on an open socket and maintains a memory hash table of block information for its specified block identifier modulo (i.e., a “shard” approach). This system maintains a set of rotating logs, referenced internally as “rotlog” files that memorialize the operation. A unique transaction identifier is included with each command sent to a Data Table processor. A “Master Data Table processor” is a version of a Data Table processor with additional functionality. It reads in log files rotated out to a Storage Area Network (SAN) by Data Table processor instances and reads them in as commands, maintaining the combined data from all shards, to ensure transactions are completed. This system is also responsible for uploading log files to a Data Warehouse.

As used herein, a “secret number” refers to, for example, a 64-bit, presumably cryptographically secure, pseudo-random signed integer created by the client for split and combine operations. The “secret number” is included in the split and combine calls and is logged along with the rest of the transaction data.

The term “Balance” refers to the value of a given block after a transaction.

“Amount” refers to a transaction amount in units unless otherwise specified or inconsistent in context.

The disclosed system may be configured to handle any number of currencies, such as from one currency up to, for example, but not limited to, about 2³¹ currencies.

The system described herein achieves perhaps the lowest theoretical cost per transaction in the context of an ultra-high scale system, with two network input/outputs (IO)s and two non-volatile storage IOs for each transaction operation, allowing a tightly coupled system to complete this operation in under two milliseconds (internal time) with relatively low-cost hardware systems. To achieve this, architectural and application features may include a simplified financial transaction model comprising two basic operations, a three-tier system model of real-time, near-real-time and offline support systems, and a fourth tier, a purpose-built software system (i.e., the core components are not “off-the-shelf” software). This model removes the necessity of establishing an identity on either side of the transaction. The purpose-built engine allows sharding of the transaction data storage while including full transactional integrity across shards, with a “single network hop” and without the bottleneck associated with systems having a central transaction controller. This segmentation allows the most difficult technical problem, the real-time transaction request response, to be completely isolated and pared down to only the requirements for responding to the request.

The system's four tiers, therefore, support each other: the near-real-time systems offload the real-time systems, and the offline systems offload the near-real-time systems. Client systems also serve to simplify the task for the real-time systems and the system's API is designed to facilitate this.

In an embodiment, the real-time and near-real-time systems are thought of as a set of systems, and are duplicated in multiple geographically separate data centers, typically at least three locations for “N+2” redundancy, e.g. the ability to safely continue real-time operations even if an entire data center is disrupted.

Near-real-time systems take care of the other half of the high-scale low-latency transaction logging system, rotating logs when they are full on each Data Table Processor system and moving the data to permanent locations on the network, including to disaster recovery sites. This task also entails the maintaining of a “master data processor” image that can be used to quickly (as in, within seconds) reload a failed Data Table Processor instance if necessary.

The other function of the near-real-time systems is to manage the pool of Data Table Processors, loading them when necessary if one is taken offline for maintenance or hardware failure. By maintaining what is essentially a “master shard” that contains all the data combined (which is constructed on the fly using the transaction logs), the near-real-time systems can load a new Data Table Processor on the order of less than one minute, keeping unplanned downtime to an absolute minimum.

The other effect of a centralized near-real-time system is that it can coordinate transaction rollbacks across shards. split and combine operations each consist of two different data table processor calls, potentially to two different shards. As such, if one shard fails to memorialize the operation after the first call was successfully made, the operation must be rolled back on the first shard. This is normally coordinated by the front-end processor, but there is a chance that system could fail at the exact moment it was necessary to do so (indeed, if a front-end processor fails, there is a high chance that it would fail in between the two calls to the data table processor since this is an IO wait state). Because of this, part of the near-real-time system's job is to ensure that transactions always come in pairs, and if they don't, it will roll back the operation as necessary to maintain system integrity.

The Haypenny real-time systems generally minimize the amount of processing such that they return their response as quickly as possible. This is enabled by Haypenny's near-real-time systems that run in the background and on separate hardware systems. The near-real-time systems also manage the pool of Data Table Processors, loading them if one is taken offline for maintenance or hardware failure. By maintaining what is essentially a “master shard” that contains all the data combined (which is constructed on the fly using transaction logs), the near-real-time systems may load a new Data Table Processor in less than 30 seconds in its maximum load, keeping unplanned downtime to a minimum. Haypenny's near-real-time systems can rapidly (as in, on the order of seconds) reload systems that have failed unless there is a total hardware failure on a node.

The Haypenny system is generally “API driven” from the front-end standpoint. End-user display content is served through either a content delivery network or through a mobile app store. This approach allows a virtually limitless amount of traffic for low cost. The Front-end (FE) processors may be written in Java©¹ and use the Jetty®² Hypertext Transfer Protocol (HTTP) server framework. Front-end processors are responsible for “house cleaning” tasks, including system metrics. Transactions are tracked along with the calling user's Internet Protocol (IP) address in the system's transaction log. The load balancer tracks Hypertext Transfer Protocol Secure (HTTPS) access. The system may operate without cookies for its front-end HTML-based applications. The Haypenny API generally uses a representational state transfer (REST) application programming interface (API), and the returned values are in JavaScript®³ Object Notation (JSON) format. ¹ Java is a registered trademark of Oracle America, Inc.² Jetty is a registered trademark of ECLIPSE.ORG FOUNDATION, INC.³ JavaScript is a registered trademark of Oracle America, Inc.

In an embodiment, REST APIs allows transactions to be created and collected. These APIs are provided using the HTTPS protocol, as it typical for services of this kind. The real-time systems include: Load balancers, which receive the initial HTTPS request from the end-user device, passing the request to the front-end Transaction Processors, which format and request and dispatch the request into one or two calls to the Data Table Processors. The Data Table Processors, provide geographically redundant storage for Haypenny transaction data. The Haypenny Registration system, supports the creation and maintenance of currency metadata.

Load Balancers are the most generic component of the Haypenny system. The Load Balancer component is critically important, not only for the necessary task of dividing up requests among a pool of front-end processors, but also to provide a “pinhole” security approach to stop probing attacks on the Front-end Processors and also to aid in mitigating distributed denial-of-service (DDOS) attacks.

Front-end Transaction processors are a pool of systems that unpack and interpret API calls, make calls to the Data Table Processors, and then return a properly formatted reply to the caller. Calls to the Data Table Processors are performed asynchronously and simultaneously such that the overall latency to the data store only takes as long as the single highest latency call.

The Front-end Processors may be written in Java and may use the Jetty HTTP server framework. The decision to go with this framework and not pure C was made very deliberately: in benchmarks the Jetty framework responded to http requests within 20% of the performance of the fastest pure C framework in terms of overhead alone. However, that overhead represented about 20% of the overall API call time, the balance being taken up by the IO to the Data Table Processors. This would mean that a move to pure C and a relatively less tested HTTP server framework would only result in approximately 4% lower latency. Java, on the other hand, offers significant advantages over C in terms of code safety, maintainability and availability of already-tested libraries for various operations.

Front-end processors are responsible for all “house cleaning” tasks including system metrics. These systems do not track individual requests. Access logging for system control and monitoring purposes is left to the load balancer component (non-transactional, “imperfect” tracking); the Data Table Processors handle the primary transaction logging.

The Data Table Processors are written in C and connect to the Front-end Processors using an open TCP/IP socket. They maintain a memory-based hash table of their blocks.

Data Table Processors are arranged in a sharding approach wherein each instance contains blocks and transactions of a certain modulo. These systems hold all Haypenny block identifiers in existence, and grow both “vertically” (data size) and “horizontally” (request volume) by adding shards.

Data Table Processors store a Haypenny block very efficiently: the core data structure for a block is 36 bytes, including hash table overhead. Hence, even a relatively modest system by today's standards can store billions of Haypenny blocks, and larger systems and additional shards allow for trillions of active blocks, which is far above long-term projections. The Data Table Processors are preferably fast and simple. They may be written in pure C as a series of open Transmission Control Protocol/Internet Protocol (TCP/IP) sockets connected to a thin layer of code over large in-memory hash tables. In some embodiments, space for blocks may be preallocated and in other embodiments, space for blocks may be dynamically allocated and deallocated on-the-fly.

The Data Table Processor also handles the task of memorializing each transaction component to non-volatile storage to ensure absolute data integrity. This subsystem consists of a rotating set of reused log files that ensure that a single operation will incur no more than a single IO to non-volatile storage. The transaction does not indicate as completed to the end-user until the data is physically written (not cached) to redundant non-volatile storage both locally and to a server in at least one physically separate geographical location.

A “Wallet” web application enables Haypenny end-users to store their Haypenny blocks, as well as to split and combine their blocks. The application also provides a reference implementation—example code—for software developers using Haypenny in their applications. Haypenny may make native mobile apps available for mobile platforms (e.g., Android®⁴, IPhone®⁵ Operating System [IOS]). These apps perform the functions the Haypenny Wallet Web Application (app) with added features enabled by the mobile platform such as enhanced security and quick response (QR) code reading. The “mint” and “wallet” applications are single-page HTML applications. Other pages may be implemented as static pages utilizing Haypenny's APIs from the front-end systems. The Haypenny Wallet HTML app utilizes browser local storage to store its data. This data never leaves the local client (unlike HTML cookies, HTML local storage is not automatically transmitted to the server). ⁴ Android is a registered trademark of GOOGLE LLC.⁵ IPhone is a registered trademark of APPLE INC.

The Wallet app is embedded in the Haypenny web application and is a static HTML/JavaScript program hosted on a Content Delivery Network (CDN), making use of the Haypenny API. This approach allows virtually limitless scale for the client application code.

The Wallet app uses browser web storage to store the wallet's data in JSON format. This means all the Wallet's data remains on the user's local system and is never transmitted elsewhere e.g. a Haypenny server. (This means that it is entirely up to the end-user to secure this data as well). When a Wallet is first used, the data in the Wallet is completely empty (the browser storage entry does not exist). As the Wallet is used, a data structure is kept in the browser session, and that data structure is saved as a JSON string to browser storage each time it is changed. The Wallet app optionally allows for simple password-based encryption of its data, and it allows this data—which is a text string that can be manipulated using cut/copy/paste controls—to be imported and exported from the Wallet app, allowing a user to save the data somewhere else, move it to another browser or app, or even email it (either password protected or in clear text).

The Wallet app provides an interface into the two primary transaction operations of the system, split and combine. For both operations, a 64-bit “secret” number is required that can be used to recover a lost returned block in case of a network failure. The Wallet app uses the Web Crypto API to generate a cryptographically secure random 64-bit integer, and then a transaction log entry is saved to the Wallet's data storage before the API call along with this secret number. (This functionality can be thwarted if the user selects the option to retain no transactions at all in their browser storage, which is not recommended).

When a block string is presented to the Wallet app that it has not already stored, it uses a combine operation to create a new block and then make API calls to retrieve that block's metadata in order to display the entry on the screen. This metadata is then kept in the Wallet app's data store for subsequent use. (The Wallet app provides a “refresh” function to re-do this operation to update any changed metadata, although this should be an unusual requirement since currency metadata is usually very stable). Because of this, when a user makes use of the Wallet app, it will usually incur only the actual transaction APIs necessary for the transaction, and not additional metadata calls.

The Haypenny Trading system, implemented in the Registration subsystem, allows holders of Haypenny currencies to trade their currencies with each other. Like the Haypenny system itself, the Trading system is unique in that it allows trades of currency with no identity being traded between the two traders, only the currency itself. To enable this, the Trading system relies upon the Haypenny Wallet to keep track of a user's trades.

The Trading system implements a multi-unit “clearing house” auction with a buy-it-now option. In this kind of system, bids at the buy-it-now price (if present) are processed immediately, and if there is a remaining balance after all buy-it-now bids are processed at the end of the auction, an auction is run that gives the highest/earliest bidder it's requested units, then if there are units remaining, the next-highest bidder, and so on. The price paid by all bidders is the same: the amount of the lowest bid that actually won any units.

A new Offer is created by specifying a block string to offer, along with the desired currency ID to trade, and the minimum bid (optionally) or the buy-it-now (optionally) trading ratio. The system will then perform a combine operation on the given block string (determining its currency type and balance) and will then store both the newly created block string along with the original (now defunct) block string.

In order to implement an identity-free trading mechanism, the system relies upon the original block string given for the new Offer as the “password” to later check upon, or collect it. Hence, when a new Offer is created (using the reg.OfferCreate API), the client will keep track of both the returned Offer ID along with the original block string in order to allow subsequent operations on that Offer, such as ending the Offer prematurely, or collecting Bids.

After an Offer is created, Offers can be discovered in the system using the reg.OfferList API, which allows lookups on either the currency ID being offered or the currency ID being accepted as payment.

Bids for the system are processed the same way as Offers: a Bid is created with a block that contains a certain number of units of a currency, and an exchange rate. When the Bid is processed, the given block is combined into a new block but also stored for subsequent use by the client.

A Bid can be checked upon/collected using the reg.BidCollect API. This same API is used by both the bidder and the offerer, wherein the Bidder provides the original block string used to create the bid, and the offerer uses the Offer's original block string. A successful Bid will have blocks ready for each side.

In both cases of an Offer and Bid, the caller may want to collect any “change” leftover after the transaction. In the case of a failed bid, for instance, the “change” block string returned will contain the amount that was bid (potentially minus the transaction fee). An Offer may end before its block has been exhausted, at which point the “change” block will contain the leftover balance.

While the Trading system allows for completely anonymous trading, an email address can be included on the reg.OfferCreate and reg.Bid API calls which will allow the system to send updates to the given email address. This email address is not scrutinized in any way besides being validated as a correctly formatted email address, and is not connected to the Haypenny user database; it does not affect the authorization to the offer or bid, which is determined solely by the original block used.

The system includes a concept called a “PBlock” which is short for “Promise block.” Whereas the block is “cash”, a PBlock is a “check.” The mechanism allows a user to create a large number of “promises” without incurring any transactions, giving them flexibility to disseminate a large number of these promises without any cost and with reduced risk.

This functionality is managed by the Reg subsystem, using the reg.PBlockCreate and reg.PBlockCash APIs. The PBlockCreate API takes in a block, an amount and a number of PBlocks to be generated, and returns a list of PBlocks, which are 33 character strings which can be used with the PBlockCash API. Analogously, the PBlockCreate API “writes a bunch of checks” and the PBlockCash API “cashes a check”.

When the PBlockCash API is called with a PBlock, it will return a block with the amount specified on the original PBlockCreate call, splitting the block that was given in that call to produce the new block. After the first call, the PBlock is invalidated, meaning a PBlock can only be used once.

The Haypenny paradigm treats block identifiers as the equivalent of physical cash and thus the system's security profile must be at the level of businesses dealing with large amounts of cash, which is to say that the system must maintain an extremely diligent level of threat detection and mitigation.

The Haypenny approach to creating a secure system for customers is fivefold:

Standards-based certification for methods and processes, including human methods and processes, such as ISO 270015, requiring any technology partner used by the system to adhere to the same standards.

An application-level approach that mitigates risk (e.g. encrypted block IDs). Industry-trusted methods and sub-systems such as the AWS Nitro Enclaves®⁶, AWS® Application Load Balancer, and the network isolation features found in AWS Virtual Private Cloud (VPC). Multiple isolated authorization realms that limit personnel to access only what they need to perform their authorized function. Periodic (e.g. daily) auditing of all system transactions to quickly detect errant or suspicious patterns, to verify system integrity, and so on. Haypenny starts its approach to securing its systems at the enterprise level, and will adhere to standards appropriate to financial institutions and select only contracted systems (viz. Amazon AWS) that adhere to these standards as well. ⁶ AWS and AWS Nitro enclaves are registered trademark of Amazon Technologies, Inc.

These standards call for, among other things: Documentation on known areas of concern, threats, vulnerabilities, and potential impact of attacks. Written procedures for granting and revoking access to systems and other security controls. Security procedures and requirements that are integrated with the management of the company. Amazon AWS, Haypenny's cloud computing provider, itself adheres to these standards and hosts a number of prominent financial institutions who have certification for these standards.

Block IDs (exposed externally as a “block string”) are stored in Haypenny's system in an encrypted state using an industry standard encryption method (AES). This means Haypenny personnel never see “live” block IDs. Access to Haypenny's Amazon AWS accounts may be secured through two-factor authentication and limited to a very small number of personnel. All access is logged and personnel are thoroughly screened.

Access to Haypenny production systems is enabled by a Virtual Private Network (VPN) connection secured with two-factor authentication. Communication between production systems is limited to only the exact traffic necessary to run the systems. Systems are not connected to any other company's systems. No production system is directly connected to the Internet, and API systems are secured using the AWS Application Load Balancer, which provides for a “pinhole” security approach for malicious request mitigation by letting only the small number of valid requests through to the front-end processors. Access to Haypenny databases are strictly limited and logged, and they are not directly connected to the Internet. Periodically (on the order of once per day), various forms of analysis are performed on Haypenny offline systems analyzing all system transactions and balances as a whole. This analysis allows the detection of many forms of DDOS attacks, and attempts to use the system fraudulently or inappropriately, as well as providing a mechanism to double-check all transactions and block balances. Using the Internet, there is always a possibility of network failure between an end-user client and Haypenny servers at any time. Because of this, a mechanism must be made available to ensure that a user recover a lost block if a call is successfully made but not returned.

The assumptions behind this approach are: That this should occur very rarely, and almost all users will never experience this sort of failure. Therefore, a longer resolution time is acceptable, on the order of a maximum of one hour (although typically only a few minutes or even a few seconds). Because of these assumptions, the mechanism to handle it resides in the offline system tier.

For split and combine operations, the client creates a “secret number” that is presumed to be a cryptographically secure pseudo-random number. It is 64 bits in size. The “secret number” is included in the split and combine calls, and that number is logged along with the rest of the transaction data. In the event that a user does not obtain a response from the server due to a network error (i.e. the operation completed on the Haypenny system but the response was not received), the user may make use of an API call and provide the secret number and block string used to make the call, and subsequently receive the lost block string in an email.

The first step in making a system perform is to define exactly what “performance” means in a given context. The Haypenny system's primary performance metric is internal transaction latency. This metric is defined as the amount of time elapsed from when a user's request reaches Haypenny servers to when the response is initiated. (It's worth noting that internet latency is not something taken into consideration in the Haypenny design, as this is both a straight-forward problem and not entirely under Haypenny's control). Besides the time metric itself, another implied metric is consistency of responses. From a user-experience standpoint, users will often remember only the slowest response time for a given service even if that time is unusual. As such, our latency metric will be qualified: the highest latency within a given test will be the one by which we measure our performance goals.

While low latency is a desirable user trait to the end-user, after a certain point, a reduced latency will not be noticeable to their human-perceived response. However, latency also determines the cost of the system: the longer resources are tied up responding to a request, the more it will cost. A higher total time taken for each request on the Front-end processor means more threads will be required to service the same number of requests per second in aggregate. An average response time of 1 ms means each thread can service 1000 requests a second, and thus a Front-end processor would require 20 threads to service 20,000 API calls per second, the design goal for the Front-end processor. If that is increased to 4 ms, then 80 threads are required, and so on. Threads do not scale in a linear fashion because of shared resource contention, which means there is only a finite number of threads that are practical.

The Haypenny system is designed to be a primary means of small payments for every single user of the Internet, every day. The system's architecture, therefore, includes the following assumptions about the ultimate scaling requirements: Every user on the internet will have multiple Haypenny currency blocks of their own. Every user on the Internet will use Haypenny to make small payments at least dozens of times a day.

Volume may be “peaky”: yearly volume may occur mostly in one or two monthly periods, monthly volume may occur more on certain day in the week (e.g. Monday morning), and daily volume may occur during specific hours and minutes. (Hence the peak volume Haypenny, as a new value transfer paradigm, may change the way consumers think about transactions as they can now happen anonymously and at extremely high speed, can be much smaller in value, be virtually free in price, and thus today's payment volume in traditional payment methods such as credit cards and payment services may multiply many times.

The Haypenny system must be scalable from the beginning to its ‘final’ requirements. Users of the Haypenny system, even at the outset, must be assured of the system's ability to scale to the capacity needs of a major internet utility.

Using the above assumptions, the following top-level scaling requirements were used in defining the architecture for the Haypenny system: The number of outstanding active Haypenny active blocks could grow into the billions. Total daily transaction volume could ultimately grow to on the order of 3 billion per day or 100 billion per month (for comparison, the total credit card transaction volume world-wide is currently about one billion per day on average). Using a peak-to-average ratio of 25, the estimated peak (peak day, peak hour, peak second) transaction volume will be approximately one million transactions per second. A key enabler of performance is to track as much metrics as possible on the system. The Haypenny engine tracks over 40 real-time metrics that track everything from application-level activity to internal backend memory usage at a granular (object) level. All API calls to Haypenny are individually benchmarked and a recent-running-average execution time is kept. All metrics are continuously scrutinized by near-real-time systems in order to save these metrics to a database for later reporting. In an embodiment, each call to an API is counted and usage counts are tracked. For example, counts may include a number of calls for: apiCallList, apiCallParamList, bid, bidCollect, bidlnfo, bidList, coinCreate, coinimageSet, coininfo, coinList, coinMint, coinMintLog, coinSearch, coinTopList, coinUpdate, contact, offerCollect, offerCreate, offerExpire, offerinfo, offerList, offerTopList, pblockCash, pblockCreate, recover, userSendPassword, and userTokenGet.

The Haypenny system has been extensively measured under a contrived load of random split and combine operations on a large number of blocks. Besides application-level benchmarks, measurements were taken at the various layers to isolate specific bits of software and hardware response times. Knowing the “absolute hardware speed” of the systems involved and comparing them to high-level benchmarks isolates the exact performance of the software itself and allows performance to be extrapolated to heavier loads.

Modern cloud computing provides a roughly linear way of scaling resources (within a very specific context, with caveats). One can purchase systems with various performance ratings, and those ratings can be tested with low-level benchmarks. Thus, if a ratio between the low-level benchmarks and the application-level benchmarks is established, a cost-performance curve can be created.

The Haypenny system's primary performance limitations ultimately come from two kinds of IO: network IO and non-volatile storage IO. A Haypenny block operation (split or combine) requires four of each kind of IO (two network IOs to the Data Table processors; two each IO writes to non-volatile storage; one each network IOs to remote storage). Based on the cloud hardware purchased and how systems are configured, network IO operations can range from 20's to 500's, which again can be measured separately. Non-volatile storage “hard write” operations (i.e. not buffered in any way) can range from approximately 50's to 500's depending on concurrent load. (The maximum estimates here depend on the physical distance between data centers, and the maximum numbers shown here are based on a typical distribution of data centers within 100 kilometers from each other for instance).

Haypenny benchmarks revealed the following: The difference between the rated hardware latencies (the “theoretical maximum speed”) and the application-level benchmarks is no more than 30% of total response time. The difference between the application-level benchmark curves and hardware-level curves is stable over a large spectrum of load levels. An average latency of a single operation to the Data Table processor under high loads of 1 ms is very achievable with currently available cloud hardware. An overall internal (processing) latency of 3 ms for a single API call (Split or combine) under very high loads is very achievable with currently available cloud hardware. The Load Balancers generally divide up requests among a pool of front-end processors, as well as provide a “pinhole” security approach to stop exploratory attacks on the Front-end Processors and to aid in mitigating distributed denial-of-service (DDOS) attacks.

In some embodiments, the system may be switched to a “redundant ring” of Data Table processors wherein each shard will be duplicated once or twice on another system separated geographically from the other systems.

The Data Table Processor also memorializes each transaction component to non-volatile storage. This subsystem, called “RotLog”, in one embodiment, comprises a rotating set of reused log files that ensure that a single operation incurs no more than a single IO to non-volatile storage. The transaction does not indicate as completed to the end-user until the data is physically written (not cached) to redundant non-volatile storage.

Near-real-time systems take care of the other half of the RotLog high-scale low-latency transaction logging system, rotating logs when they are full on each Data Table Processor system and moving the data to permanent locations on the network, including to disaster recovery sites. This includes maintenance of a “master data processor” image that may quickly (as in, within seconds) reload a failed Data Table instance.

Using the Internet, network failure between an end-user client and Haypenny servers is possible at any time. Because of this, a mechanism resides in the offline system tier to ensure that a user recovers a lost block if a call is successfully made but not returned. This preferably occurs rarely, such that few users experience this sort of failure. A longer resolution time is acceptable as compared to prior art systems, on the order of a few seconds up to one hour.

The method for servicing user-lost transactions due to network failure is designed to minimize any impact on the real-time systems as well by allowing the response time for handling network failure to be minutes instead of milliseconds.

In some embodiments, the Haypenny system may take an “active/hot spare” approach to system redundancy, as opposed to an “active/active” approach at the system level (i.e., not at the hardware level, where indeed redundant non-volatile storage is utilized). This means that system failures are handled by quickly moving production loads to new systems with newly loaded data rather than actively simultaneously maintaining (at least) two redundant active copies of the same real-time data. Cloud computing enables extremely rapid, automatic creation of replacement systems and makes the maintenance of “hot spares” straightforward and practical. With these combined factors, the disclosed system may respond to a lost Data Table system in under one minute, minimizing downtime in this situation. If a user does not obtain a response from the server due to a network error (i.e., the operation completed on the Haypenny system, but the response was not received), a customer service system may accept the secret number used and the block, returning the lost block in email.

In an embodiment, Haypenny's offline systems include a data warehouse-style database that holds an (encrypted) copy of all transactions, blocks, and all other metadata of the system for use for offline processing. This system is connected to applications that perform auditing of transactions (and allow external auditors to do the same), analysis of the system's usage for system management purposes*, and other analysis related to the running of the service, such as editorial control over metadata.

The Haypenny system requires a secure, robust and scalable hardware and networking infrastructure. In an embodiment, Amazon Web Services (AWS) may be utilized as an infrastructure provider. Support is provided for a complete and integrated product offering that includes everything the system needs, such as, redundancy in networks and physical locations, available High Performance Computing (HPC) components including ultra-low-latency network connections. AWS also is a clear market leader in the cloud computing space with a track-record of hosting extremely security-sensitive systems such as banks and other financial infrastructure.

In an embodiment, the Haypenny Registration System may be a front-end HTTP system handling APIs connected to a straightforward relational database management system (RDBMS) which handles the needs of Haypenny coin makers and provides metadata services for coins for transactional users (e.g., name, description, etc.). Unlike the transaction systems, the registration system has a smaller data set that grows much slower. High-volume reads may be cached (i.e., coin descriptions, settings, etc. may be slightly delayed in their appearance to the end user without adverse consequences). Uptime requirements are not as pronounced for these systems.

To maintain system integrity and consistent performance, approximately 40 different application-level metrics may be gathered from each Front-end Processor at 10 second intervals. This data may be fed into a relational database for further processing and reference.

The Haypenny system's primary performance metric is internal transaction latency. This metric is defined as the amount of time elapsed from when a user's request reaches Haypenny servers to when the response is initiated.

The Haypenny systems' primary performance limitations generally come from two kinds of IO: network IO and non-volatile storage IO. A Haypenny block operation (split or combine) requires two of these IOs each. Based on cloud hardware, network IO operations may range from 20 μs to 500 μs. Non-volatile storage “hard write” operations (i.e., not buffered in any way) may range from 50 μs to 500 μs depending on concurrent load.

Latency determines the cost of the system: cost increases the longer resources are tied up responding to a request. Higher latency implies more network IO transpiring, and more IO to non-volatile storage occurring. Data piling up at high loads means more costs associated with fast storage, data transfer, and so on. Hence, the system's design makes its operations as small and as fast as possible.

Another implied metric is consistency of responses. From a user-experience standpoint, users remember the slowest response time for a given service even if that time is unusual.

The disclosed system may be used as follows. A user may navigate a browser to https://haypenny.net/and follow the instructions to create a new currency by giving it a name and description. The user may mint a specified number of units of the new currency, which is deposited as a block in the user's Wallet application on the same website. Using the Wallet “split” function, the user may create a new block from the just minted block. The user may give the resultant block string to a second user. The second user may enter that block string into their Wallet application on the same website. They have the specified number of units of the new currency. The second user may split their block and give it to third parties, etc.

In an example, a newspaper displays a charge of a predetermined number of units of a selected Haypenny currency to read the article. The amount of money in question is presumably very small for a single view of one article—far too small to practically be handled with a credit card transaction, for instance. The user uses the split command on their Haypenny Wallet (or some other application that provides the same functionality) to create a block string with that amount, and the user enters that string on the newspaper's website to get past the paywall. The user imparts no personal information during this transaction to the newspaper's system, only the block string. The newspaper's website software uses a combine operation to take in the user's block and verify it was the right amount. The combine operation increments the value of the newspaper's block and deletes the block the user sent. After this operation, the newspaper's software allows the (anonymous) user to view the selected article.

Haypenny makes a “Wallet” web application available on its website in order to provide: An application for Haypenny end-users to store their Haypenny blocks, and to split and combine their blocks. A reference implementation—example code—for software developers using Haypenny in their applications.

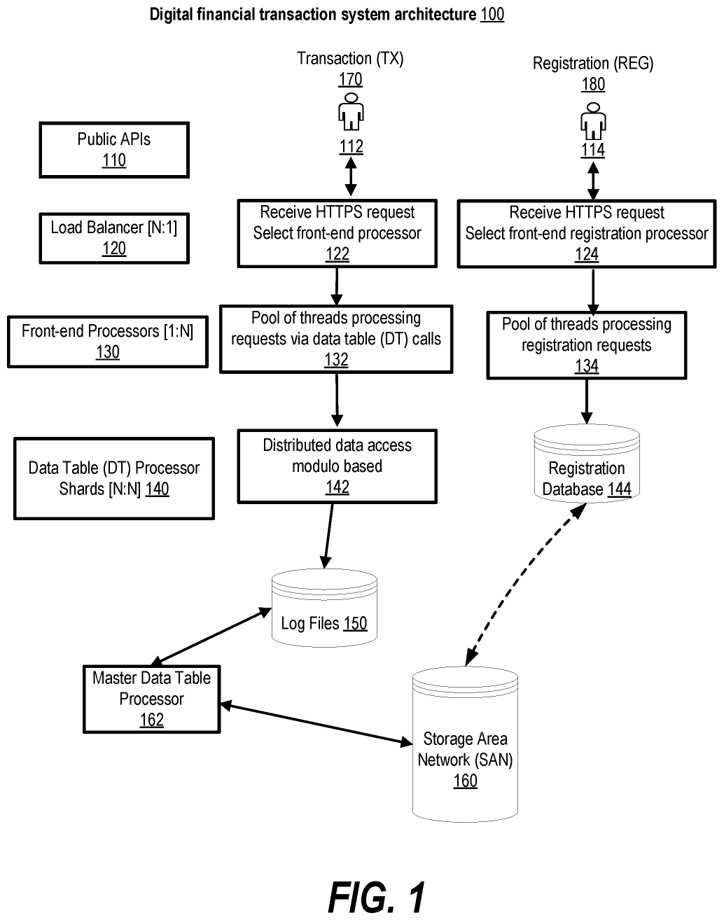

FIG. 1 shows a diagram depicting a schematic overview of an embodiment of a digital financial transaction system architecture 100. The public APIs 110 include the block operations split and combine which may be received from user 112 requesting a transaction (TX) 170. Alternatively user 114 may be utilizing the public APIs 110 to make a registration (REG) request 180, such as, mint to create a currency. Each user, such as, user 112 and user 114 interfaces with the disclosed system utilizing a web user interface (not shown). The system has a three-tier system model of real-time, near-real-time and offline support. Haypenny's real-time systems include load balancer [N:1] 120, front-end (FE) processor [1:n] 130, which receive HTTPS requests and select a front-end processors 122 from a pool of threads processing requests via data table (DT) calls 132 processor shards [N:N] 140. API 110 is provided using HTTPS protocol. Load balancer 120 receive the initial HTTPS request from the end-user device. Front-end processors 130 format and dispatch the request into one or two calls to BT processor shards 140. The front-end processors 130 also return a JSON formatted reply to the API 110. The Data Table or BT Processors shards 140 provide low-latency storage for Haypenny block data. Data Table Processors 140 are arranged in a sharding approach wherein each instance contains blocks and transactions of a selected modulo (mod). These systems may hold all Haypenny block identifiers in existence and may grow both “vertically” (data size) and “horizontally” (request volume) by adding shards.

A Web User Interface/public APIs 110 connects through the Internet to a Load Balancer 120 and presents requests including a block. The Load Balancer 120 selects an available Front-end (FE) processor 130 that accepts HTTP JSON requests, e.g., storage requests and maintains a list of Data Table Processors 140 that are each given a modulo range that they are meant to handle. The Front-end Processor 130 uses a modulo function to determine the appropriate Data Table Processor 140. The load balancer 120 connects the Web User Interface 110 to the selected data table processor 140. The Data Table Processor 140 loads log file data into a Storage Area Network (SAN) 160. A Master Data Table processor 160 reads log files on the Storage Area Network 160. The Master Data Table processor 162 loads data on to a Data Warehouse 160.

Calls are made to Front-end (FE) processors 134 to mint new currency. The Front-end Processor 130 responds to two requests, “split” and “combine”. The “split” and “combine” commands each comprise two Data Table processor 140 commands which are potentially different instances. If there is a failure of either command, then the commands are rolled back on both shards.

The Haypenny Registration system supports the Haypenny coin making (“mint”) user interface and may generally operate as follows. The Web User Interface 110 connects through the Internet to a Load Balancer 124 with registration requests, e.g., user instructions that specify current metadata and commands. The Load Balancer 124 selects an available a Front-end Registration Processor 134 and connects the Web User Interface 110 to that instance. The Front-end Registration Processor 134 communicates with a Registration Database 144, e.g., an off-the-shelf relational database to fulfill the request, such as currency registration, and stores values.

A System Control Processor or master BT processor 162 processes the log files 160 and communicates with the data warehouse 160 to ensure data is stored permanently and processed to ensure consistency. The System Control Processor 162 may be a simple web interface manipulated processor that allows the overall system to be maintained and monitored. To control, coordinate, and gather statistics from the various systems, a System Control Processor 162 may use an off-the-shelf relational database to store its data.

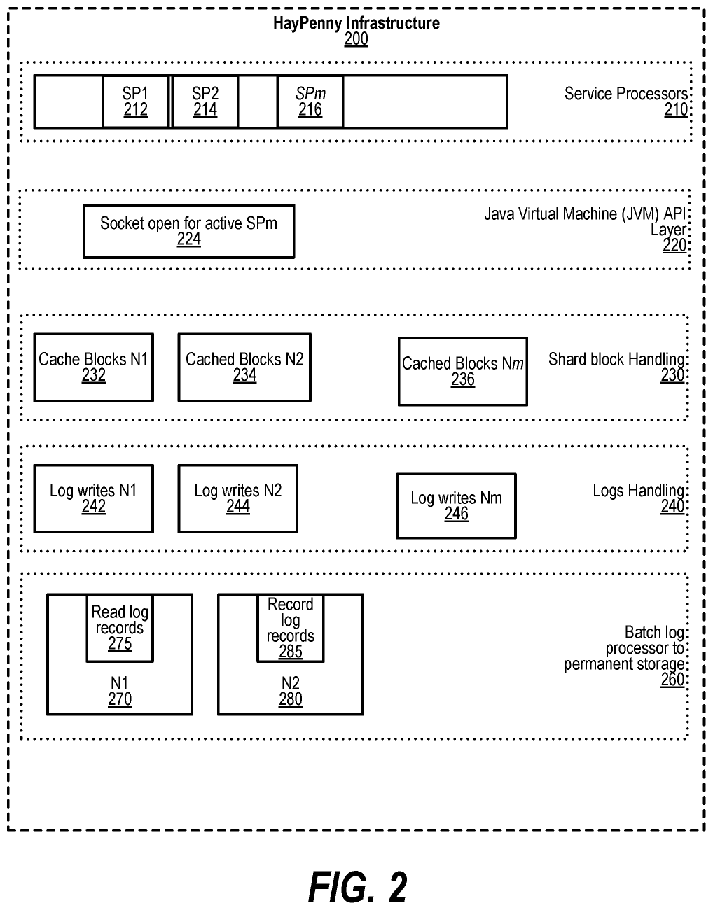

FIG. 2 depicts a layering of HayPenny infrastructure 200. When a REST API is received by a load balancer 120, a service processor 210 is selected from a set of service processors SP1 212, SP2 214, . . . , SPm 116. The selected service processor, say SPm utilizes a Java Virtual Machine (JVM) to process the API 220 by opening a socket for SPm 224 to the shard block handling 230 layer which maintains cached blocks N1 232, cached block N2 234, . . . , cached block Nm 246. When changes are made at the shard block handling 230 layer, a record of the changes are made by utilizing the rotlog interface and writing records to the logs handling layer 240. For each shard block handling 230 update operation, there is a corresponding write to the log handling layer 240, such as, log write N1 242, log write N2 244, . . . , log write Nm 246. While logs are being written, they are also consumed by batch log processor to permanent storage 260 that reads and processes each of the records, such as node 1 270 read log records 275, node 2 280, read log records 285, . . . . In an embodiment, a full set of rotating logs is allocated for each shard. Data is written sequentially filling a log and once filled that log is available to be read and copied to permanent storage. Once the data is copied, that log is available to be reused and new data written.

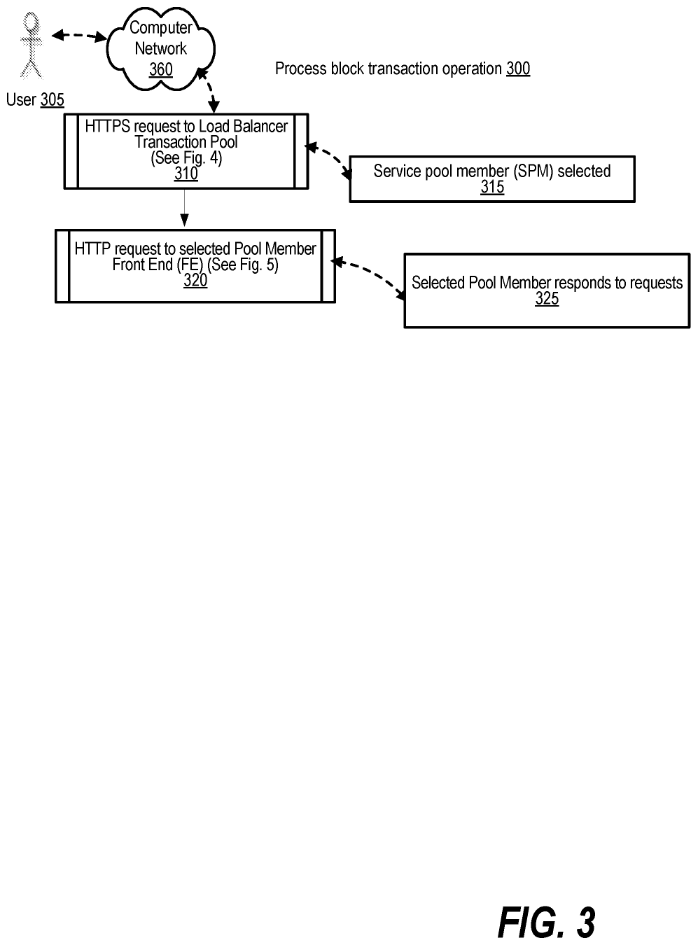

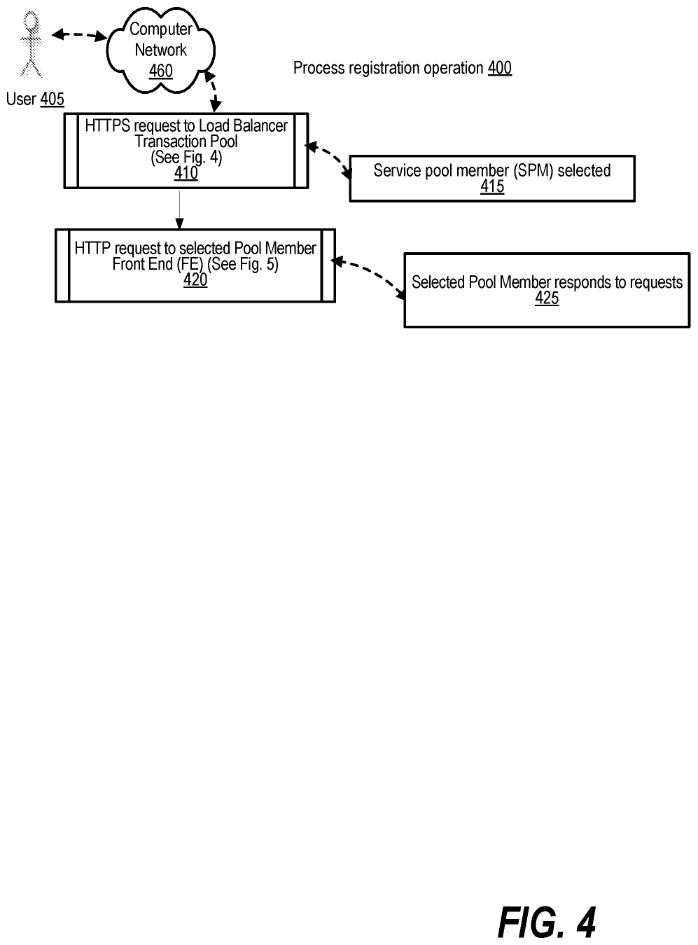

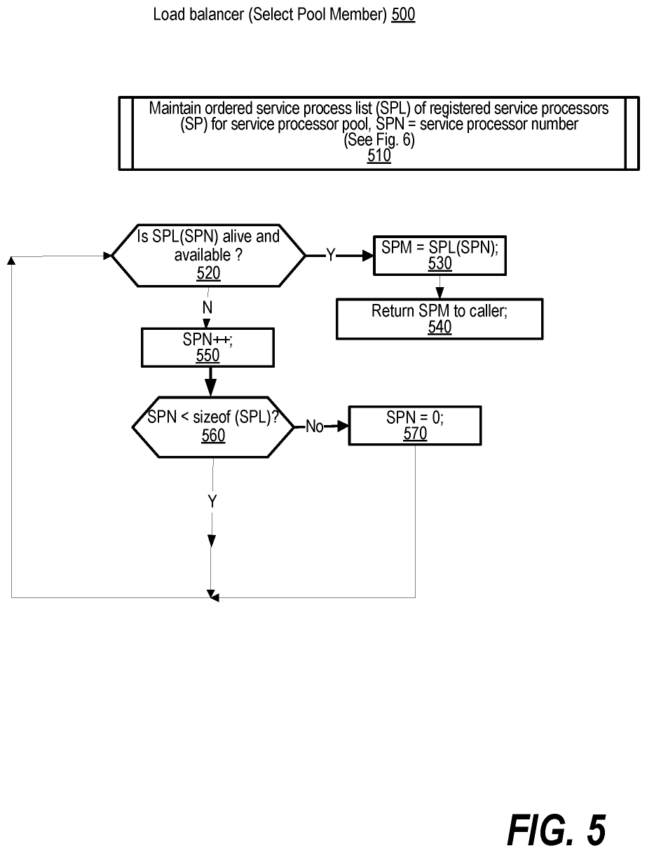

FIG. 3 depicts a schematic flow of a process Data Table operation 300. A user 305 utilizing computer network 360 accesses a REST API which at predefined process 310 performs an HTTPS request to Load Balancer Transaction Pool routine (see FIG. 4 and corresponding text for processing details). At step 315, the process services pool member (SPM) is selected. At predefined process 320, the process performs the HTTP request to selected Pool Member Front End (FE) routine (see FIG. 5 and corresponding text for processing details). At step 325, the process selects a pool member which responds to requests.

FIG. 4 depicts a schematic flow of a process registration operation 400. A user 405 utilizing computer network 460 accesses a REST API which at predefined process 410 performs an HTTPS request to Load Balancer Transaction Pool routine (see FIG. 4 and corresponding text for processing details). At step 415, the process services pool member (SPM) is selected. At predefined process 420, the process performs the HTTP request to selected Pool Member Front End (FE) routine (see FIG. 5 and corresponding text for processing details). At step 425, the process selects a pool member which responds to requests.

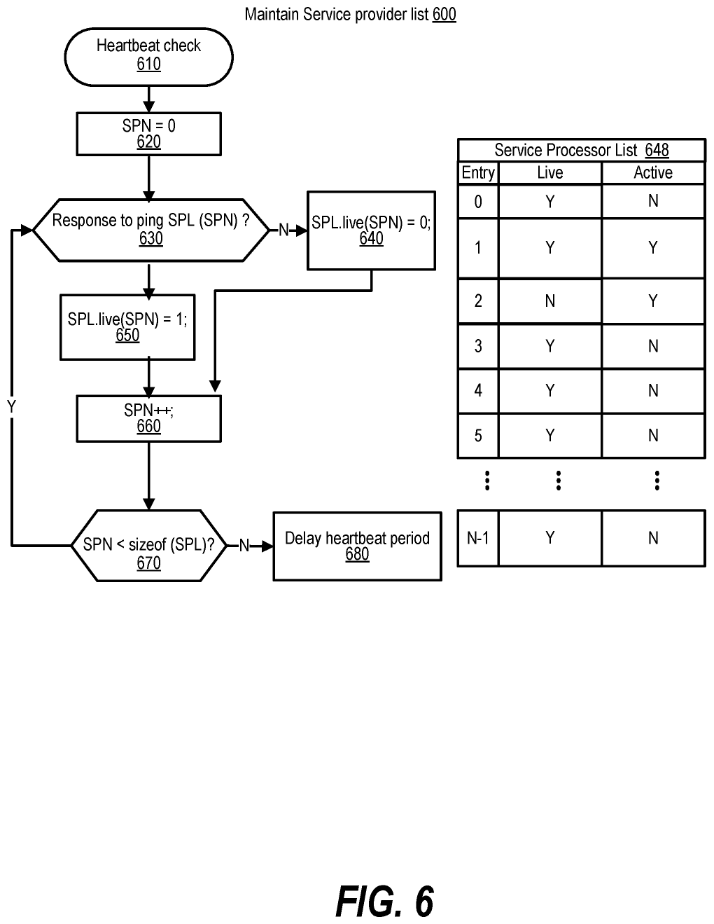

FIG. 5 depicts a flowchart of a load balancer selecting a service provider member (SPM) 500. At predefined process 510, the process performs the Maintain ordered service process list (SPL) of registered service processors (SP) for service processor pool, SPN=service processor number routine (see FIG. 6 and corresponding text for processing details). The process determines as to whether is SPL(SPN) alive and available (decision 520). If not is SPL(SPN) alive and available, then decision 520 branches to the ‘N’ branch which loops back to 520 This looping continues until SPL(SPN) alive and available, at which point decision 520 branches to the ‘Y’ branch exiting the loop. If is SPL(SPN) alive and available, then decision 520 branches to the ‘Y’ branch. On the other hand, if not is SPL(SPN) alive and available, then decision 520 branches to the ‘N’ branch. At step 530, the process sets SPM=SPL(SPN). At step 540, the process returns SPM to caller. At step 550, the process sets SPN++. The process determines as to whether SPN<sizeof (SPL) (decision 560). If SPN<sizeof (SPL), then decision 560 branches to the ‘Y’ branch. On the other hand, if not SPN<sizeof (SPL), then decision 560 branches to the ‘N’ branch. At step 570, the process sets SPNs=0.

FIG. 6 depicts a flow of a process that maintains a service provider list 600. At step 610, the process performs a heartbeat check. This check is performed periodically. At step 620, the process sets SPN=0. The process determines as to whether response to ping SPL (SPN) (decision 630). If response to ping SPL (SPN), then decision 630 branches to the ‘Y’ branch. On the other hand, if not response to ping SPL (SPN), then decision 630 branches to the ‘N’ branch. At step 640, the process sets SPL.live (SPN)=0. At step 650, the process sets SPL.live (SPN)=1. At step 660, the process set SPN++. The process determines as to whether SPN<sizeof (SPL) (decision 670). If SPN<sizeof (SPL), then decision 670 branches to the ‘Y’ branch which loops back to 630. This looping continues until SPN==sizeof (SPL), at which point decision 670 branches to the ‘N’ branch exiting the loop. At step 680, the process delays heartbeat period. At step 648, the process maintains a service Processor List. Each entry has status indicators. The live status indicator is set when there is a response to the ping. The live status indicator is reset when there is no response to the ping. The Active status indicator is set when the service processor list element is chosen to process a request by the load balancer. The Active status indicator is reset when the processing of the operation is completed.

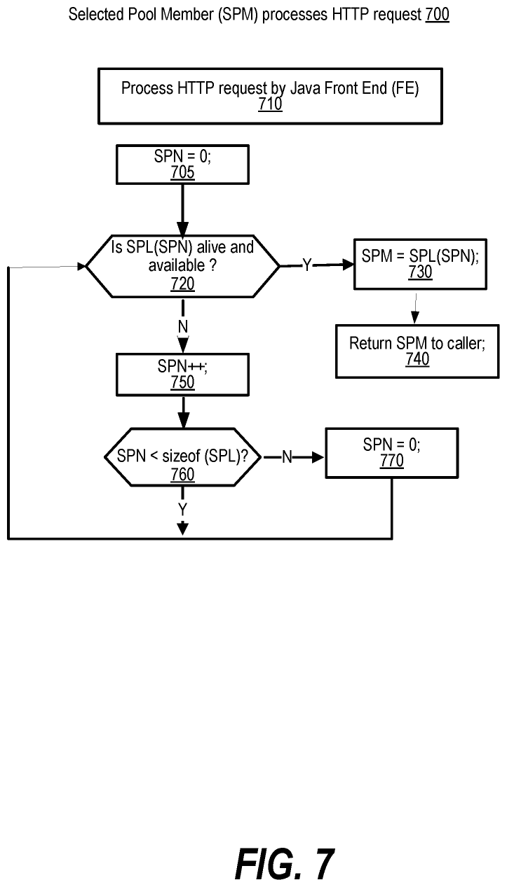

FIG. 7 shows the steps to select a pool member (SPM) to process an HTTP request 700. During initialization the process sets SPN=0 at step 705. At step 710, the process receives an HTTP request by Java Front End (FE). At step 750, the process sets SPN=0. The process determines as to whether is SPL(SPN) alive and available (decision 720). If is SPL(SPN) alive and available, then decision 720 branches to the ‘Y’ branch. On the other hand, if not is SPL(SPN) alive and available, then decision 720 branches to the ‘N’ branch. At step 730, the process sets SPM=SPL(SPN). FIG. 7 processing thereafter returns to the calling routine (see FIG. 6) at 740. At step 750, the process sets SPN++. The process determines as to whether SPN<sizeof (SPL) (decision 760). If SPN<sizeof (SPL), then decision 760 branches to the ‘Y’ branch. On the other hand, if not SPN<sizeof (SPL), then decision 760 branches to the ‘N’ branch. At step 770, the process sets SPN=0.

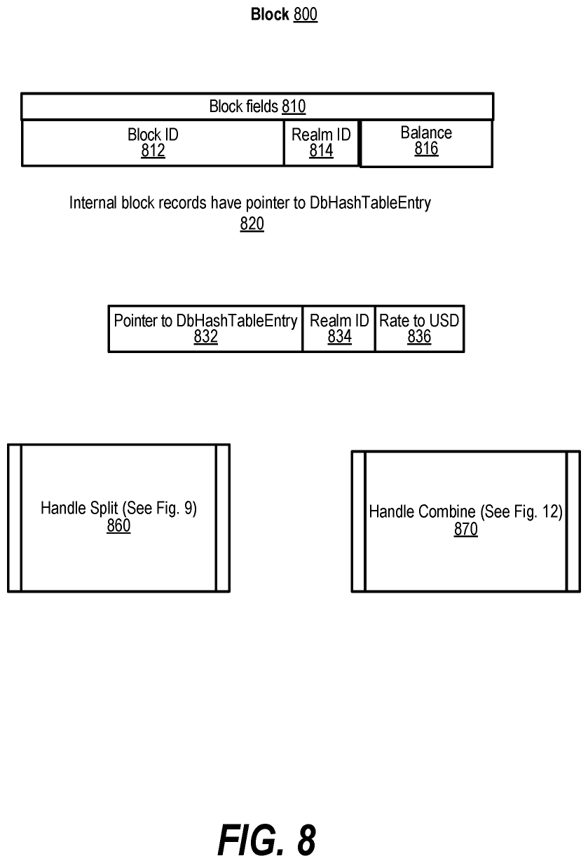

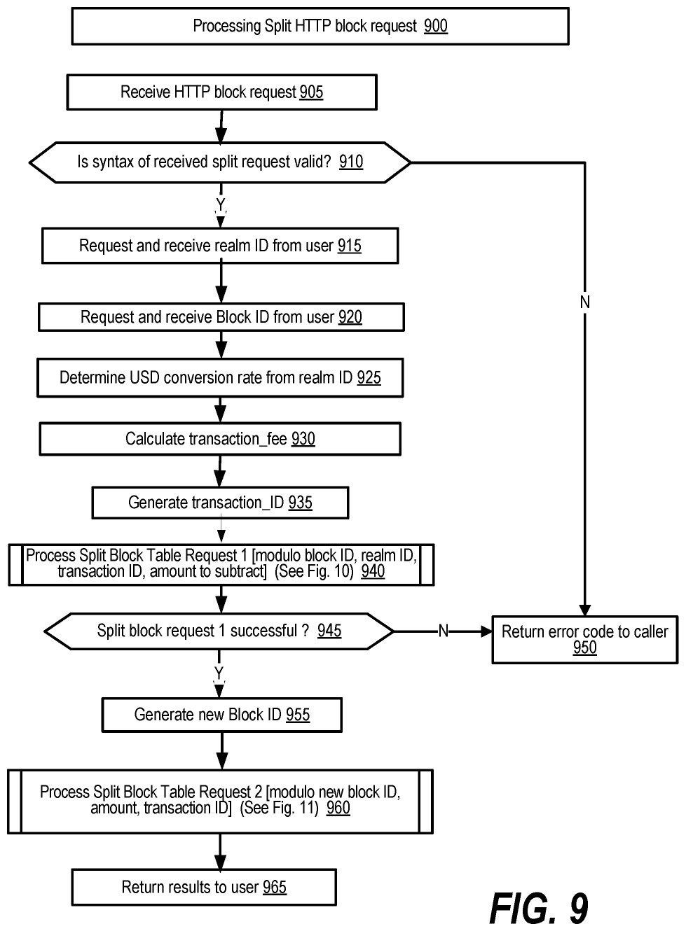

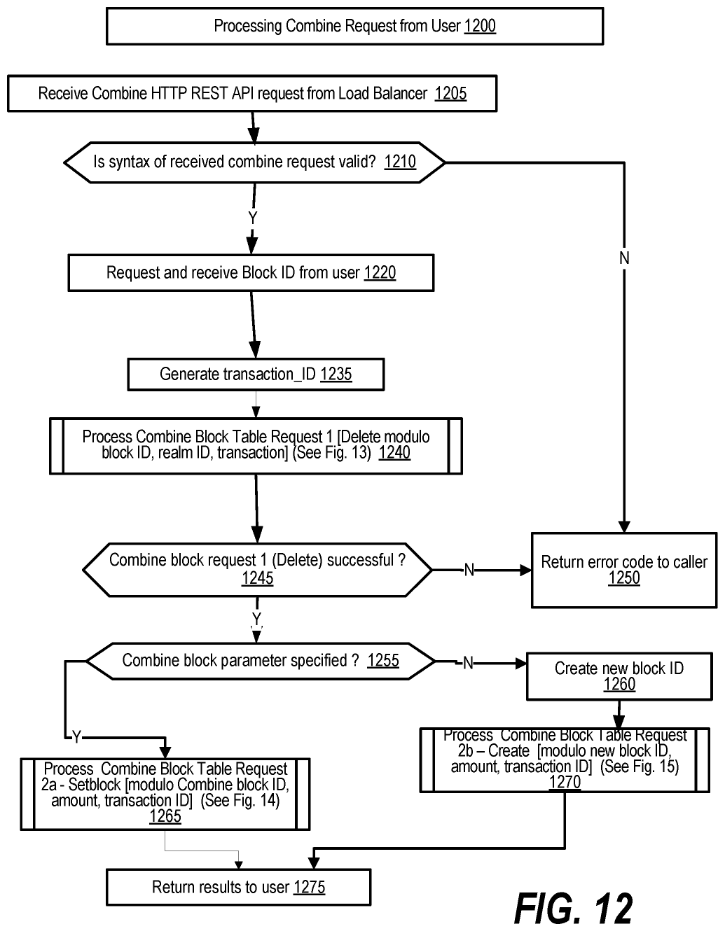

FIG. 8 provides a schematic view of a block and block processing operations 800. Block fields 810 include a block identification (ID) 812, a realm ID 814, and a balance 816. The internal block records have a pointer to DBHashTableEntry 820. In an embodiment, the internal structure also includes a pointer to DBHashTableEntry 832, a realm ID 834, and a rate to USD 836. At predefined process 860, the process performs the Handle split routine (see FIG. 9 and corresponding text for processing details). At predefined process 870, the process performs the Handle Combine routine (see FIG. 12 and corresponding text for processing details).

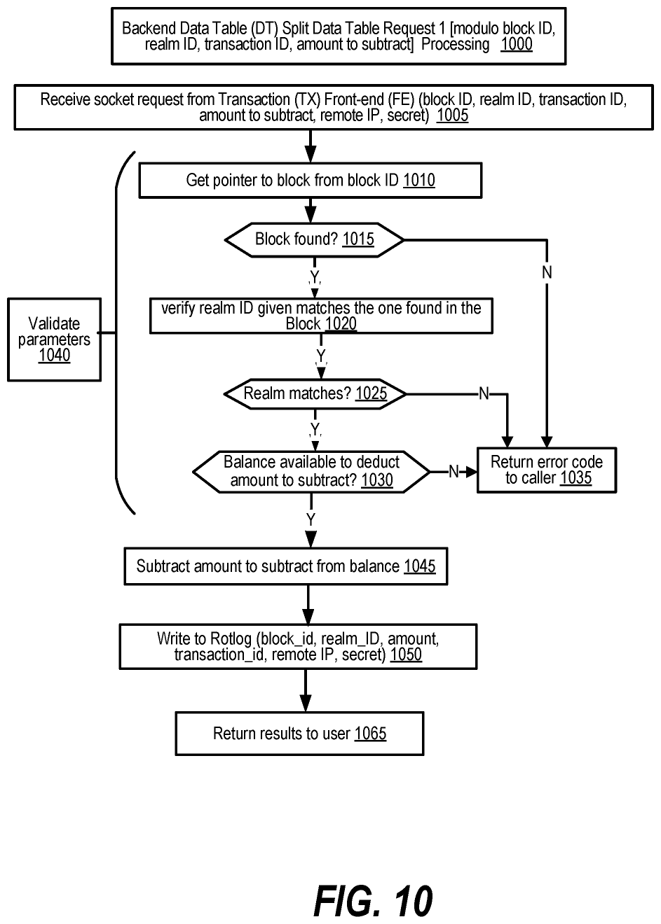

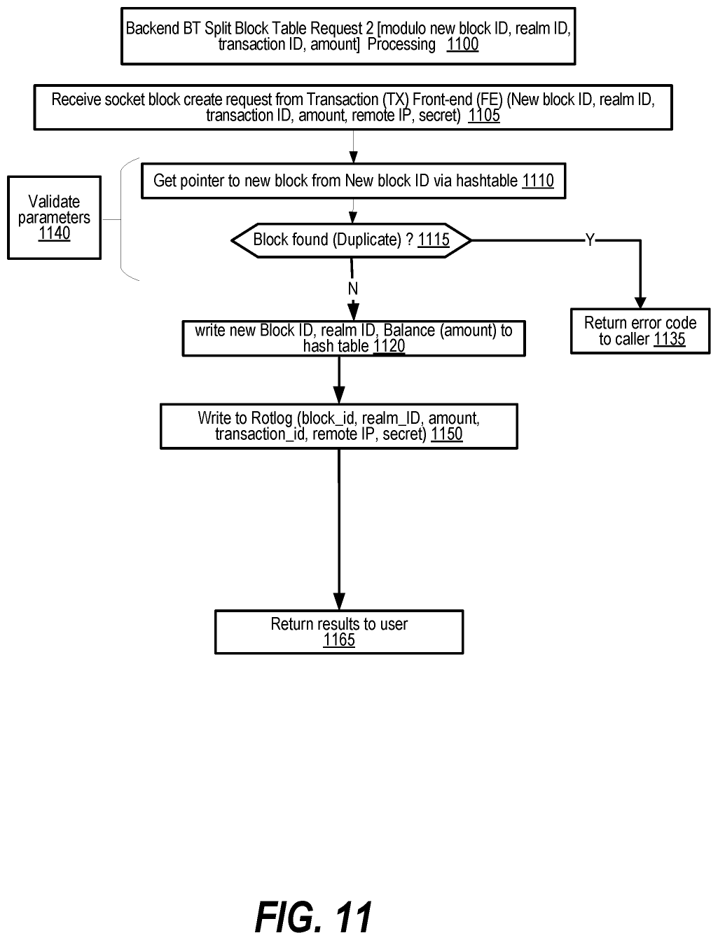

FIG. 9 shows the steps taken by a process to split HTTP block request 900. At step 905, the process receives HTTP block request. The process determines as to whether is syntax of the received split request is valid (decision 910). If is syntax of received split request valid, then decision 910 branches to the ‘Y’ branch. On the other hand, if not is syntax of received split request valid, then decision 910 branches to the ‘N’ branch. At step 915, the process requests and receive realm ID from user. At step 920, the process requests and receive block ID from user. At step 925, the process determines USD conversion rate from realm ID. At step 930, the process calculates transaction_fee. At step 935, the process generates transaction_ID. At predefined process 940, the process performs the Process split Data Table Request 1 [modulo block ID, realm ID, transaction ID, amount to subtract] routine (see FIG. 10 and corresponding text for processing details). The process determines as to whether split block request 1 successful (decision 945). If split block request 1 successful, then decision 945 branches to the ‘Y’ branch. On the other hand, if not split block request 1 successful, then decision 945 branches to the ‘N’ branch. FIG. 9 processing thereafter returns to the calling routine (see FIG. 8) at 950. At step 955, the process generates new Block ID. At predefined process 960, the process performs the Process split Data Table Request 2 [modulo new block ID, amount, transaction ID] routine (see FIG. 11 and corresponding text for processing details). FIG. 9 processing thereafter returns to the calling routine (see FIG. 8) at 965.

FIG. 10 shows the steps taken to process a backend Data Table (DT) split Data Table Request 1 [modulo block ID, realm ID, transaction ID, amount to subtract] processing 1000. At step 1005, the process receives socket request from Transaction (TX) Front-end (FE) (block ID, realm ID, transaction ID, amount to subtract, remote IP, secret). At step 1010, the process gets pointer to block from block ID. The process determines as to whether block found (decision 1015). If block found, then decision 1015 branches to the ‘Y’ branch. On the other hand, if not block found, then decision 1015 branches to the ‘N’ branch. At step 1020, the process verifies Realm ID given matches the one found in the Block. The process determines as to whether realm matches (decision 1025). If realm matches, then decision 1025 branches to the ‘Y’ branch. On the other hand, if not realm matches, then decision 1025 branches to the ‘N’ branch. The process determines as to whether balance available to deduct amount to subtract (decision 1030). If balance available to deduct amount to subtract, then decision 1030 branches to the ‘Y’ branch. On the other hand, if not balance available to deduct amount to subtract, then decision 1030 branches to the ‘N’ branch. FIG. 10 processing thereafter returns to the calling routine (see FIG. 9) at 1035. At step 1040, the process validates parameters. At step 1045, the process subtracts amount to subtract from balance. At step 1050, the process writes to Rotlog (block_id, realm_ID, amount, transaction_id, remote IP, secret). FIG. 10 processing thereafter returns to the calling routine (see FIG. 9) at 1065.

FIG. 11 shows the steps taken to process a backend Data Table (DT) Request 2 [modulo new block ID, realm ID, transaction ID, amount] 1100. At step 1105, the process receives socket block create request from Transaction Front-end (TX FE) (New block ID, realm ID, transaction ID, amount, remote IP, secret). At step 1110, the process gets pointer to new block from New block ID via hash table. The process determines as to whether block found (Duplicate) (decision 1115). If block found (Duplicate), then decision 1115 branches to the ‘Y’ branch. On the other hand, if not block found (Duplicate), then decision 1115 branches to the ‘N’ branch. At step 1120, the process writes new block ID, Realm, Balance (amount) to hash table. FIG. 11 processing thereafter returns to the calling routine (see FIG. 9) at 1135. At step 1140, the process validates parameters. At step 1150, the process writes to Rotlog (block_id, realm_ID, amount, transaction_id, remote IP, secret). FIG. 11 processing thereafter returns to the calling routine (see FIG. 9) at 1165.

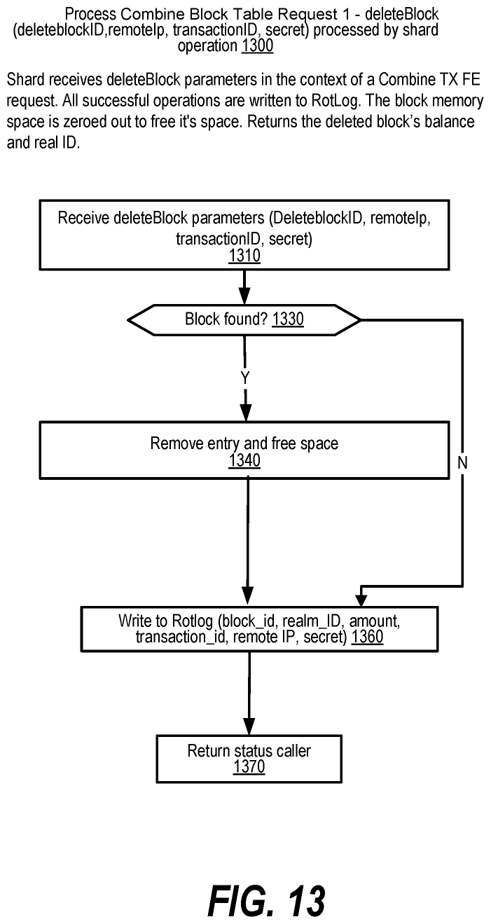

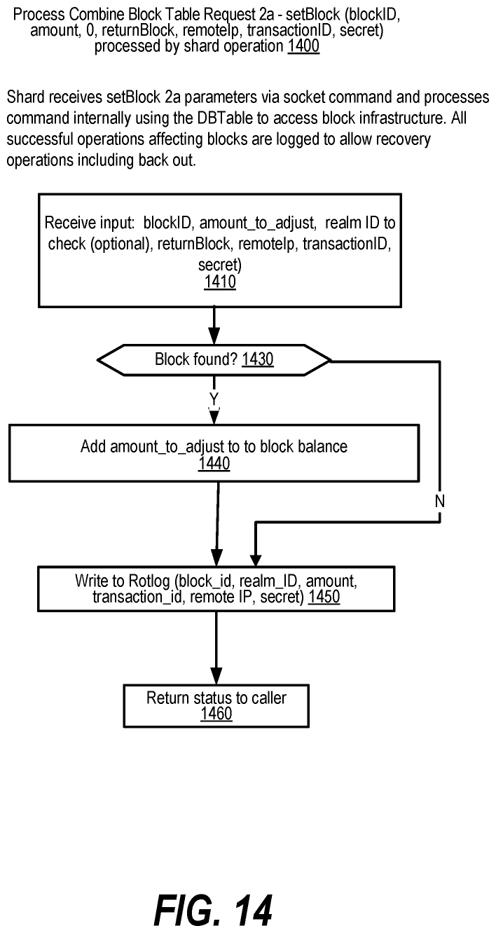

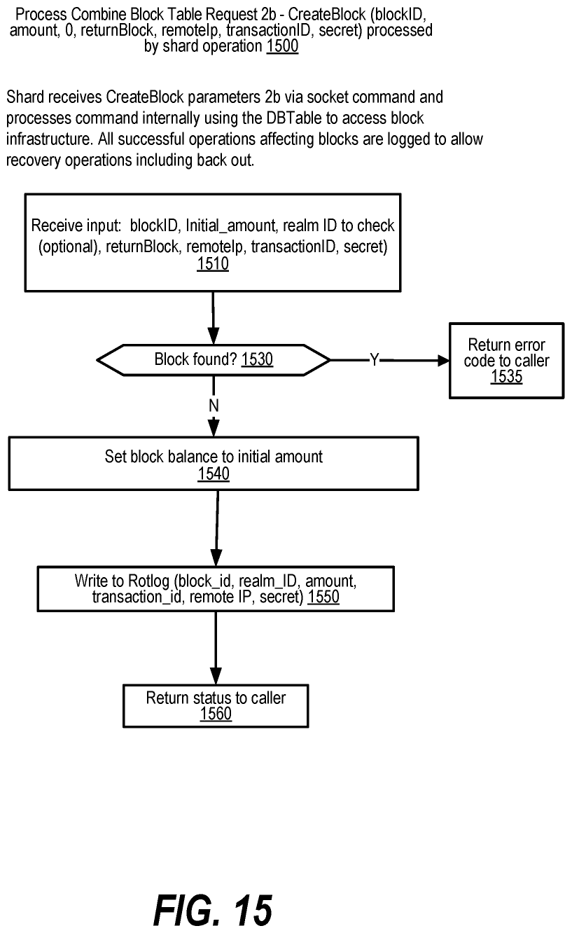

FIG. 12 shows the steps taken by a process that processes combine Request from User 1200. At step 1205, the process receives combine HTTP REST API request from Load Balancer. The process determines as to whether is syntax of received combine request valid (decision 1210). If is syntax of received combine request valid, then decision 1210 branches to the ‘Y’ branch. On the other hand, if not is syntax of received combine request valid, then decision 1210 branches to the ‘N’ branch. At step 1220, the process requests and receive block ID from user. At step 1235, the process generates transaction_ID. At predefined process 1240, the process performs the Combine Data Table Request 1 [Delete modulo block ID, realm ID, transaction] routine (see FIG. 13 and corresponding text for processing details). The process determines as to whether combine block request 1 (Delete) successful (decision 1245). If combine block request 1 (Delete) successful, then decision 1245 branches to the ‘Y’ branch. On the other hand, if not combine block request 1 (Delete) successful, then decision 1245 branches to the ‘N’ branch. FIG. 12 processing thereafter returns to the calling routine (see FIG. 8) at 1250. The process determines as to whether combine block parameter specified (decision 1255). If combine block parameter specified, then decision 1255 branches to the ‘Y’ branch. On the other hand, if not combine block parameter specified, then decision 1255 branches to the ‘N’ branch. At step 1260, the process creates new block ID. At predefined process 1265, the process performs the Combine Data Table Request 2a—Setblock [modulo Combine block ID, amount, transaction ID] routine (see FIG. 14 and corresponding text for processing details). At predefined process 1270, the process performs the Process Data Table Request 2b [modulo new block ID, amount, transaction ID] routine (see FIG. 15 and corresponding text for processing details). FIG. 12 processing thereafter returns to the calling routine (see FIG. 8) at 1275.

FIG. 13 shows the steps to perform the Combine Data Table Request 1—deleteBlock (deleteblockID,remoteIp, transactionID, secret) processed by shard operation 1300. At step 1310, the process receives deleteBlock parameters (DeleteblockID, remoteIp, transactionID, secret). The process determines as to whether block found (decision 1330). If block found, then decision 1330 branches to the ‘Y’ branch. On the other hand, if not block found, then decision 1330 branches to the ‘N’ branch. At step 1340, the process removes entry and frees space. At step 1360, the process writes to Rotlog (block_id, realm_ID, amount, transaction_id, remote IP, secret). FIG. 13 processing thereafter returns to the calling routine (see FIG. 8) at 1370.

Shard receives deleteBlock parameters in the context of a Combine TX FE request. All successful operations are written to RotLog. The block memory space is zeroed out to free it's space. Returns the deleted block's balance and real ID.

FIG. 14 shows the steps taken to process Combine Data Table Request 2a—setBlock (blockID, amount, 0, returnBlock, remoteIp, transactionID, secret) processed by shard operation 1400. The Shard receives setBlock parameters via socket command and processes command internally using the DBTable to access block infrastructure. All successful operations affecting blocks are logged to allow recovery operations including back out. At step 1410, the process receives input: blockID, amount_to_adjust, add_or_subtract amount, realm ID to check (optional), returnBlock, remoteIp, transactionID, secret). The process determines as to whether block found (decision 1430). If block found, then decision 1430 branches to the ‘Y’ branch. On the other hand, if not block found, then decision 1430 branches to the ‘N’ branch. At step 1440, the process adds amount to_adjust to block balance. At step 1450, the process writes to Rotlog (block_id, realm_ID, amount, transaction_id, remote IP, secret). FIG. 14 processing thereafter returns to the calling routine (see FIG. 8) at 1460.

FIG. 15 shows the steps to perform Combine Data Table Request 2b—CreateBlock (blockID, amount, 0, returnBlock, remoteIp, transactionID create a block, CreateBlock (blockID, amount, 0, returnBlock, remoteIp, transactionID, secret) processed by shard operation. At step 1510, the process receives input: blockID, Initial_amount, realm ID to check (optional), returnBlock, remoteIp, transactionID, secret). The process determines as to whether block found (decision 1530). If block found, then decision 1530 branches to the ‘Y’ branch. On the other hand, if not block found, then decision 1530 branches to the ‘N’ branch. FIG. 15 processing thereafter returns to the calling routine (see FIG. 12) at 1535. At step 1540, the process sets block balance to initial amount. At step 1550, the process writes to Rotlog (block_id, realm_ID, amount, transaction_id, remote IP, secret). FIG. 15 processing thereafter returns to the calling routine (see FIG. 12) at 1560.

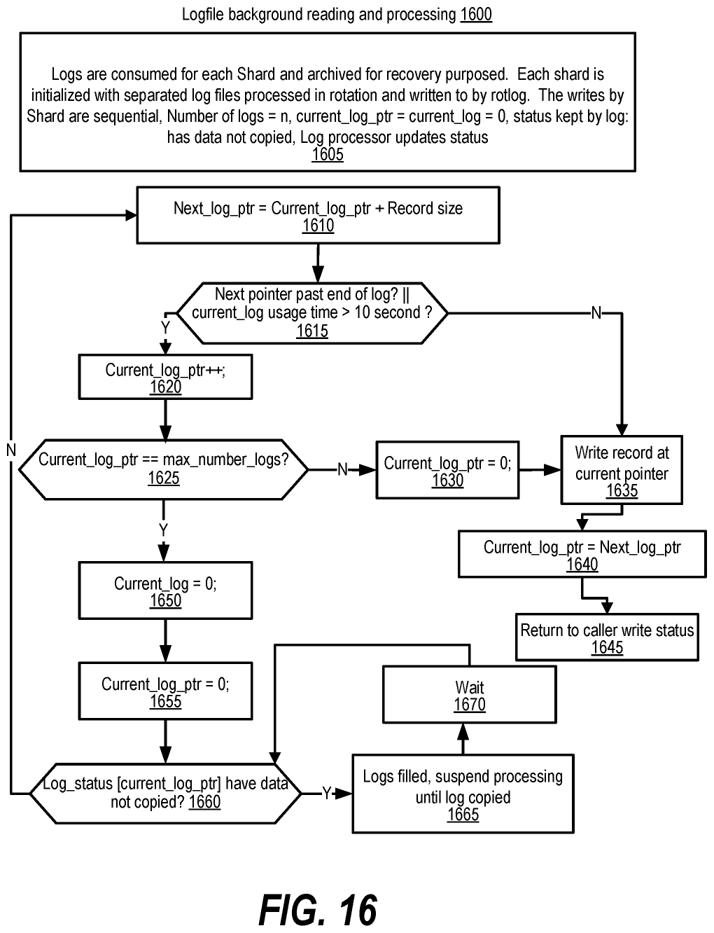

FIG. 16 shows the steps taken by a background process that reads and processes logfiles 1600. Logs are consumed for each Shard and archived for recovery purposes. Each shard is initialized with separated log files processed in rotation and written to by rotlog. At step 1605, the writes by Shard are sequential, Number of logs=n, current_log_ptr=current_log=0. The status is kept by log: has data not copied, Log processor updates status. The writes by shard are sequential, number of logs=n, current_log_ptr=current_log=0, status kept by log: has data not copied, log processor updates status data store. At step 1610, the process sets next_log_ptrs=Current_log_ptr+Record size. The process determines as to whether next pointer past end of log II current log usage time>10 seconds (decision 1615). If next pointer past end of log II current log usage time>10 seconds, then decision 1615 branches to the ‘Y’ branch. On the other hand, if not next pointer past end of log∥current log usage time>10 seconds, then decision 1615 branches to the ‘N’ branch. The process determines as to whether next pointer past end of log (decision 1615). If next pointer past end of log, then decision 1615 branches to the ‘Y’ branch. At step 1620, the process sets current_log_ptr++. The process determines as to whether current_log_ptr==max_number_logs (decision 1625). If current_log_ptr==max_number_logs, then decision 1625 branches to the ‘Y’ branch. On the other hand, if not current_log_ptr==max_number_logs, then decision 1625 branches to the ‘N’ branch. At step 1635, the process writes record at current pointer. At step 1640, the process set current_log_ptrs=Next_log_ptr. FIG. 16 processing thereafter returns at 1645. At step 1650, the process sets current_logs=0. At step 1655, the process sets current_log_ptrs=0. The process determines as to whether log_status [current_log_ptr] have data not copied (decision 1660). If log_status [current_log_ptr] have data not copied, then decision 1660 branches to the ‘Y’ branch which loops back to 1610. This looping continues until log_status [current_log_ptr] has all data copied, at which point decision 1660 branches to the ‘N’ branch exiting the loop. At step 1665, the logs are filled, processing is suspended until log is copied. At step 1670, the process waits till log is copied.

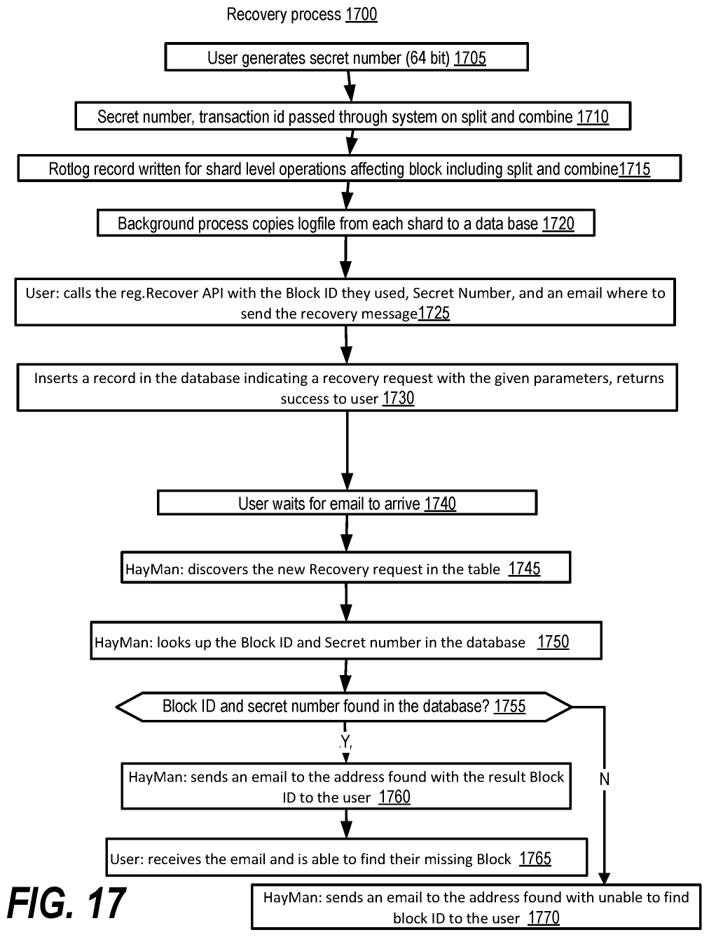

FIG. 17 shows the steps taken by a recovery process 1700. At step 1705, the process users generates a secret number (64 bit). At step 1710, the secret number and transaction id are passed through system on split and combine. At step 1715, the rotlog record written for shard level operations affecting block including split and combine. At step 1720, a background process copies logfile from each shard to a data base. At step 1725, a user calls the reg.Recover API with the Block ID they used, Secret Number, and an email where to send the recovery message. At step 1730, the system inserts a record in the database indicating a recovery request with the given parameters, returns success to user. At step 1740, the users waits for email to arrive. At step 1745, hayMan discovers the new Recovery request in the table. At step 1750, the hayMan looks up the Block ID and Secret number in the database. The process determines as to whether block ID and secret number found in the database (decision 1755). If block ID and secret number found in the database, then decision 1755 branches to the ‘Y’ branch. On the other hand, if not block ID and secret number found in the database, then decision 1755 branches to the ‘N’ branch. At step 1760, hayMan sends an email to the address found with the result Block ID to the user. At step 1765, the user receives the email and is able to find their missing Block. At step 1770, hayMan sends an email to the address found with unable to find block ID to the user.

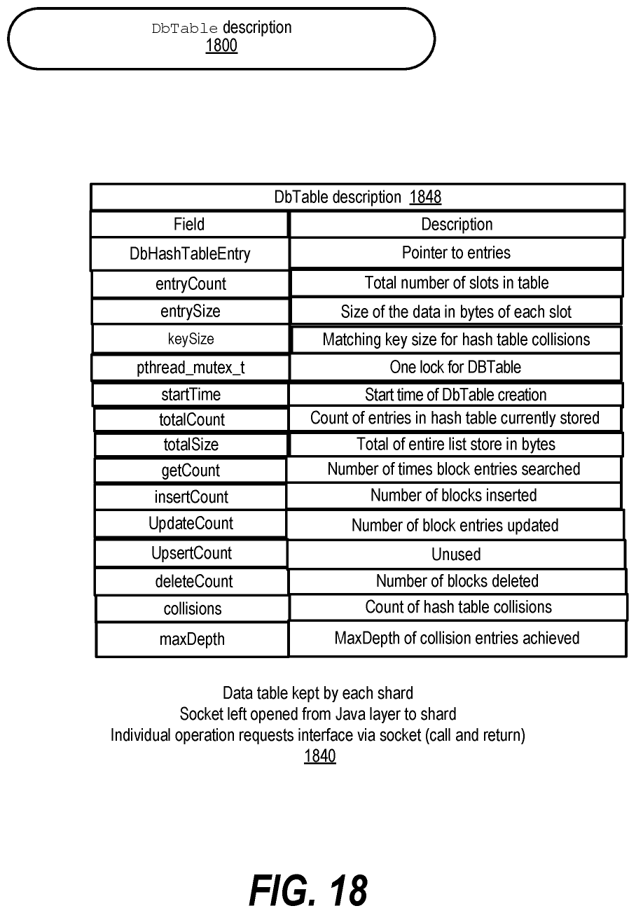

FIG. 18 depicts a DBtable description 1800. In an embodiment, an example of a DbTable description 1848 may have the following fields and descriptions:

| Field | Description |
|---|---|
| DbHashTableEntry | Pointer to entries |
| entryCount | Total number of slots in table |
| entrySize | Size of the data in bytes of each slot |
| keySize | Matching key size for hash table collisions |
| pthread_mutex_t | One lock for DBTable |
| startTime | Start time of DbTable creation |
| totalCount | Count of entries in hash table currently stored |
| totalSize | Total of entire list store in bytes |
| getCount | Number of times block entries searched |
| insertCount | Number of blocks inserted |
| UpdateCount | Number of block entries updated |
| UpsertCount | Unused |
| deleteCount | Number of blocks deleted |
| collisions | Count of hash table collisions |
| maxDepth | MaxDepth of collision entries achieved |

In an embodiment, the Data table kept by each shard Socket may be left opened from the Java layer to shard. Individual operation requests may interface via socket requests (call and return) 1840.

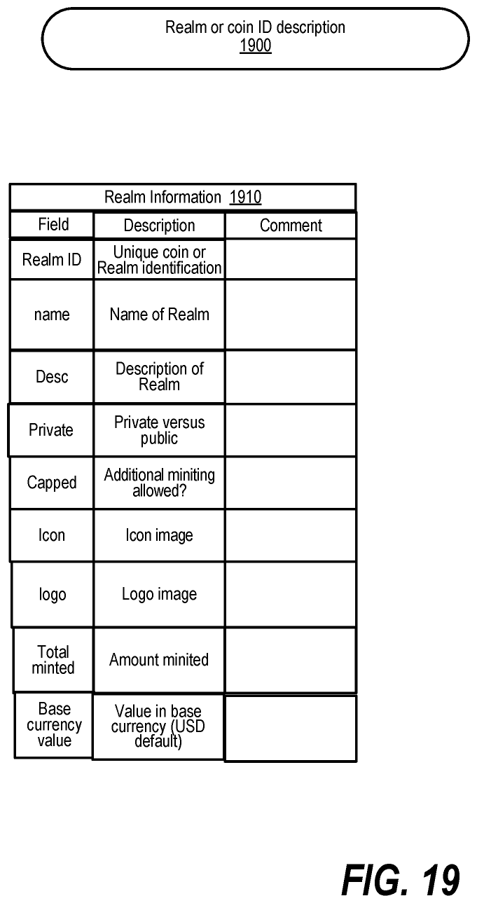

FIG. 19 depicts a Realm or coin ID description 1900. In an example embodiment, Realm Information 1910 may be defined as follows:

| Field | Description |
|---|---|
| Relm ID | Unique coin or relm identification |
| name | Name of relm |
| Desc | Description of relm |
| Private | Private versus public |
| Capped | Additional miniting allowed? |
| Icon | Icon image |
| logo | Logo image |
| Total minted | Amount minited |
| Base currency value | Value in base currency (USD default) |

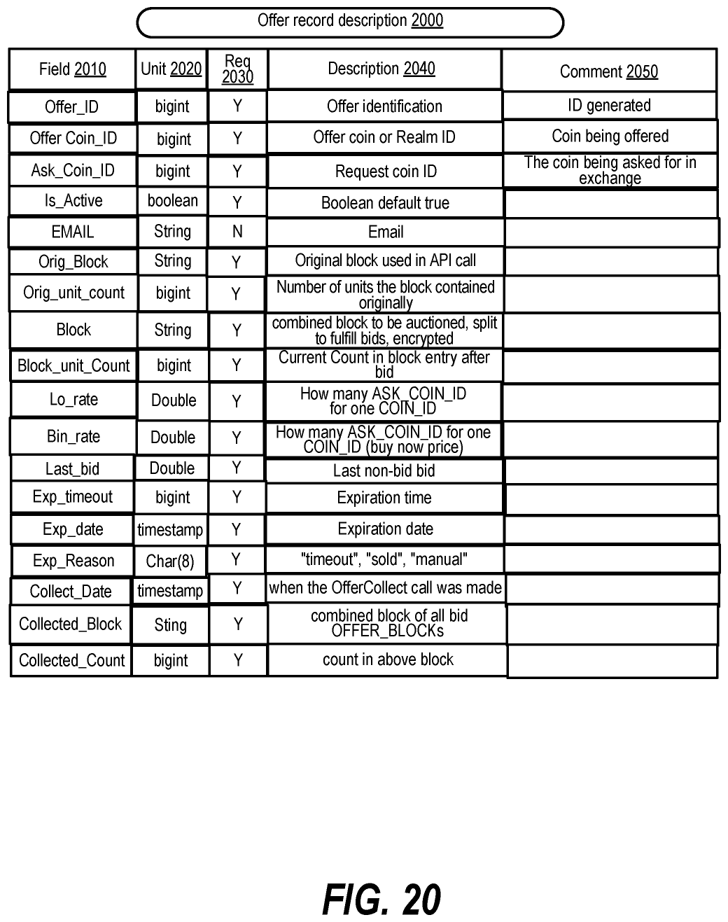

FIG. 20 depicts an embodiment of an offer record description 2000. In the following example, the field 2010 is followed by unit 2020 and indication of whether the field is required 2030, and followed by a description 2040 including any comment 2050.

| Field | Unit | Req | Description |
|---|---|---|---|
| Offer_ID | bigint | Y | Offer identification where ID is |
| | | | generated. |
| Offer Coin_ID | bigint | Y | Offer coin or relm ID, where Coin_ID is |
| | | | the coin being offered. |
| Ask_Coin_ID | bigint | Y | Request coin ID, where Ask_Coin_ID is |
| | | | the coin being asked for in exchange. |
| Is_Active | boolean | Y | Boolean default true |
| EMAIL | String | N | Email |
| Orig_Block | String | Y | Original block used in API call |
| Orig_unit_count | bigint | Y | Number of units the block contained |
| Block | String | Y | combined block to be auctioned, split |
| | | | to fulfill bids, encrypted |
| Block_unit_Count | bigint | Y | Current Count in block entry after |
| | | | bid |
| Lo_rate | Double | Y | How many ASK_COIN_ID for one |
| | | | COIN_ID |
| Bin_rate | Double | Y | How many ASK_COIN_ID for one |
| | | | COIN_ID (buy now price) |
| Last_bid | Double | Y | Last non-bid bid |
| Exp_timeout | bigint | Y | Expiration time |
| Exp_date | timestamp | Y | Expiration date |
| Exp_Reason | Char(8) | Y | “timeout”, “sold”, “manual” |
| Collect_Date | timestamp | Y | when the OfferCollect call was made |
| Collected_Block | String | Y | combined block of all bid |
| | | | OFFER_BLOCKs |
| Collected_Count | bigint | Y | count in above block |

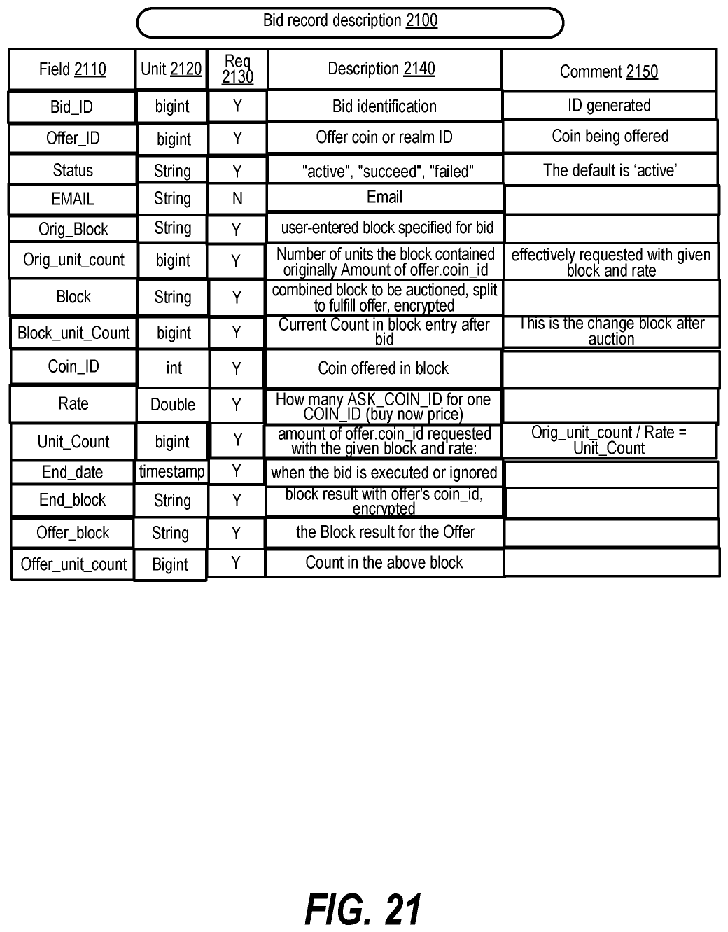

FIG. 21 depicts a bid record description 2100. In the following example, the field 2110 is followed by unit 2120, an indication of whether the field is required 2130, and the description 2140 In the following example, the field 2110 is followed by unit 2120 and indication of whether the field is required 2130, and the followed by a description 2140 with a comment 2150 included in the description 2140.

| Field | Unit | Req | Description |
|---|---|---|---|
| Bid_ID | bigint | Y | Bid identification ID, ID generated |
| Offer_ID | bigint | Y | Offer coin or relm ID |
| Status | String | Y | “active”, “succeed”, “failed” |
| | | | default active |
| EMAIL | String | N | Email |
| Orig_Block | String | Y | user-entered block specified for bid |
| Orig_unit_{—} | bigint | Y | Number of units the block contained |
| count | | | Originally, Amount of offer.coin_id |
| | | | effectively requested with given |
| | | | block and rate |
| Block | String | Y | combined block to be auctioned, |
| | | | Split to fulfill offer, encrypted |
| Block_unit_{—} | bigint | Y | Current Count in block entry after |
| Count | | | Bid. This is the change block after |
| | | | auction |
| Coin_ID | int | Y | Coin offered in block |
| Rate | Double | Y | How many ASK_COIN_ID for one |
| | | | COIN_ID (buy now price) |
| Unit_Count | bigint | Y | amount of offer.coin_id requested |
| | | | with the given block and rate: |
| | | | Orig_unit_count/Rate = Unit_{—} |
| | | | Count |
| End_date | timestamp | Y | when the bid is executed or ignored |
| End_block | String | Y | block result with offer's coin_id, |
| | | | encrypted |
| Offer_block | String | Y | the Block result for the Offer |
| Offer_unit_{—} | Bigint | Y | Count in the above block |
| count | | | |

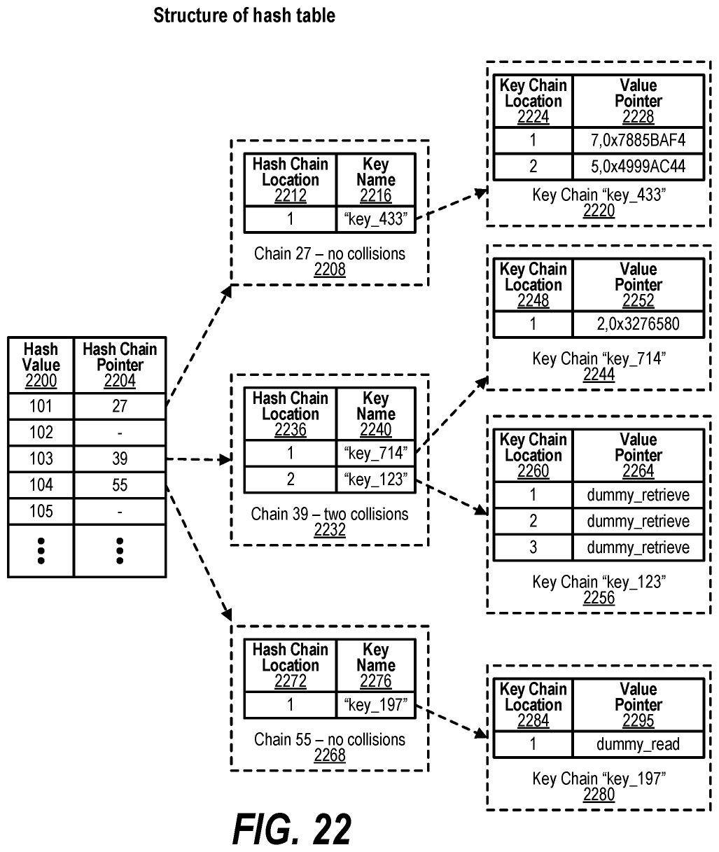

FIG. 22 depicts a schematic diagram of an example embodiment of a structure for a hash table. A distributed key-value store uses the hash table structure is localized to a node or shard. The hash value (or hash index) 2200 is used to select a hash chain pointer 2204 that points to a hash chain listing all the keys associated with the hash index. Each hash chain location (2212, 2224, 2236, 2248, 2260, 2272, 2284) contains the key name (2216, 2240, 2276) and a pointer to the key chain location (2224, 2248, 2260, 2284) that contains a list of value pointers (2252, 2264, 2295) for the value (or data) associated with the key. The “key” can be the first field of the name, other meta-data, and the like. It is also possible to store the value associated with a key directly inside the hash chain instead of indirectly accessing the value using pointers. The latter method is more efficient when the value field is small. Hash Value 2200 and Hash Chain Pointer 2204 depicts an example of a section of a hash table. For purposes of illustration, FIG. 22 depicts a case where the keys are in a unique location, that is, a specific entry in a specific hash table on a specific node. Thus, the sets of keys located in various hash tables are disjoint. However, in general, for reliability or performance reasons, it may be desirable to locate a key in multiple locations in a consistent manner. FIG. 22 depicts the set of blocks that are identified by hash table. In the example, the hash value (or index) 2200 starting from 101 to 105 shows pointers to the hash chains corresponding to each hash value. The hash chain pointer 2204 at hash index location 101 indicates chain pointer 27 2208. Hash chain 27 2208 has a single entry with a key name 2216 of “key_433” 2220 indicating no collisions as does Hash chain 55 2268. The hash chain pointer 2204 at hash index location 103 indicates chain pointer 39. Hash chain 39 2232 has two entries with a key name 2240 of “key_714” 2244 and “key_123” 2256 indicating two collisions or keys with the same hash value. Each entry in the hash chains contain the key name and a pointer to the associated key chain that reference the data associated with the key name. For example, entry 1 in hash chain 27 points to key chain describing the data associated with “key_433” 2220. Key chain has two entries indicating the data associated with “key_433” have two blocks. Key Chain Location entry 1 describes a block containing 7 bytes located at address 0x7885BAF4 and entry 2 describes a block containing 5 bytes located at address 0x4999AC44. Summing the sizes of the two block indicates there are 12 bytes of data associated with “key_433.”

The infrastructure may contain flags indicating the type of entries for example, value versus pointer and structured as a linked list or fields indicating counts of items, back up references, as various embodiments may be used. The values in the infrastructure may be entries in other tables or could be virtual addresses subject to being homed in different nodes or even metadata. Associated with each key is a hash value that is a mathematical function performed on the key which may be a number, a set of numbers, text, or a mixture of text and numbers.

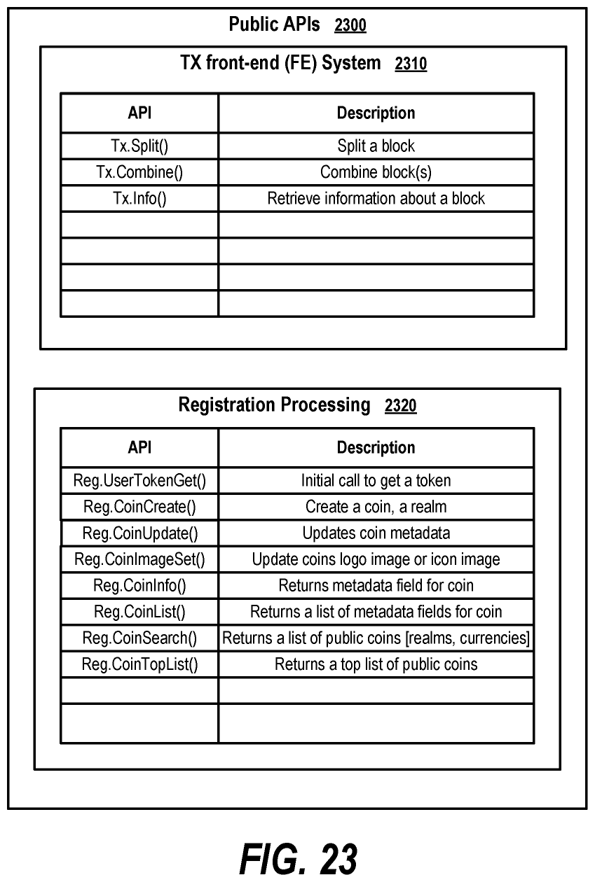

FIG. 23 depicts public APIs 2300. The TX front-end (FE) System API 2320, include the following:

| API | Description |
|---|---|
| Tx.Split( ) | Split a block |
| Tx.Combine( ) | Combine block(s) |
| Tx.Info( ) | Retrieve information about a block |

The Registration processing 2320 APIs include:

| API | Description |
|---|---|
| Reg.UserTokenGet( ) | Initial call to get a token |
| Reg.CoinCreate( ) | Create a coin, a realm |
| Reg.CoinUpdate( ) | Updates coin metadata |
| Reg.CoinImageSet( ) | Update coins logo image or icon image |
| Reg.CoinInfo( ) | Returns metadata field for coin |
| Reg.CoinList( ) | Returns a list of metadata fields for coin |
| Reg.CoinSearch( ) | Returns a list of public coins [realms, currencies] |
| Reg.CoinTopList( ) | Returns a top list of public coins |

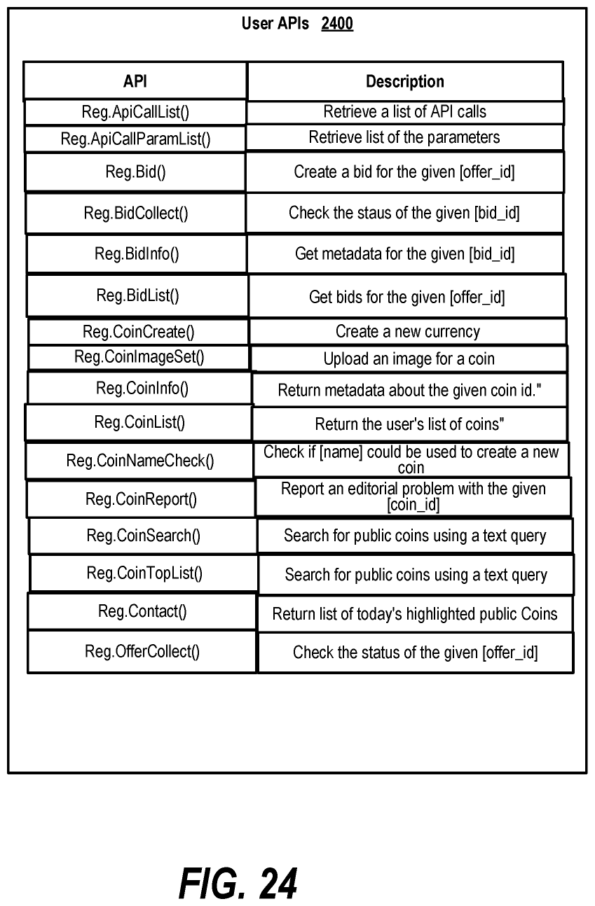

FIG. 24 depicts user APIs 2400. The user APIs include the following:

| API | Description |
|---|---|
| Reg.ApiCallList( ) | Retrieve a list of API calls |
| Reg.ApiCallParamList( ) | Retrieve list of the parameters |
| Reg.Bid( ) | Create a bid for the given [offer_id] |
| Reg.BidCollect( ) | Check the staus of the given [bid_id] |
| Reg.BidInfo( ) | Get metadata for the given [bid_id] |
| Reg.BidList( ) | Get bids for the given [offer_id] |
| Reg.CoinCreate( ) | Create a new currency |
| Reg.CoinImageSet( ) | Upload an image for a coin |
| Reg.CoinInfo( ) | Return metadata about the given coin id.″ |
| Reg.CoinList( ) | Return the user's list of coins″ |
| Reg.CoinNameCheck( ) | Check if [name] could be used to create a new |
| | coin |
| Reg.CoinReport( ) | Report an editorial problem with the given |
| | [coin_id] |
| Reg.CoinSearch( ) | Search for public coins using a text query |
| Reg.CoinTopList( ) | Search for public coins using a text query |
| Reg.Contact( ) | Return list of today's highlighted public Coins |
| Reg.OfferCollect( ) | Check the status of the given [offer_id] |

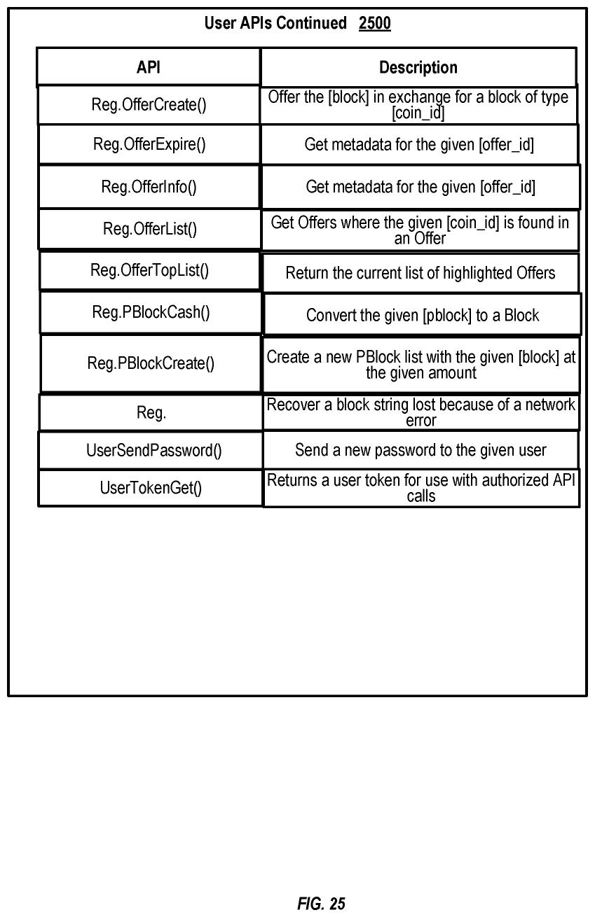

FIG. 25 continues with the depiction of user APIs 2500. The additional user APIs include the following:

| API | Description |
|---|---|
| Reg.OfferCreate( ) | Offer the [block] in exchange for a block of |
| | type [coin_id] |
| Reg.OfferExpire( ) | Get metadata for the given [offer_id] |
| Reg.OfferInfo( ) | Get metadata for the given [offer_id] |
| Reg.OfferList( ) | Get Offers where the given [coin_id] is |
| | found in an Offer |
| Reg.OfferTopList( ) | Return the current list of highlighted Offers |
| Reg.PBlockCash( ) | Convert the given [pblock] to a Block |
| Reg.PBlockCreate( ) | Create a new PBlock list with the given |
| | [block] at the given amount |
| Reg.Recover( ) | Recover a block string lost because of a |
| | network |
| Reg.UserSendPassword( ) | Send a new password to the given user |
| Reg.UserTokenGet( ) | Returns a user token for use with authorized |
| | API Calls |

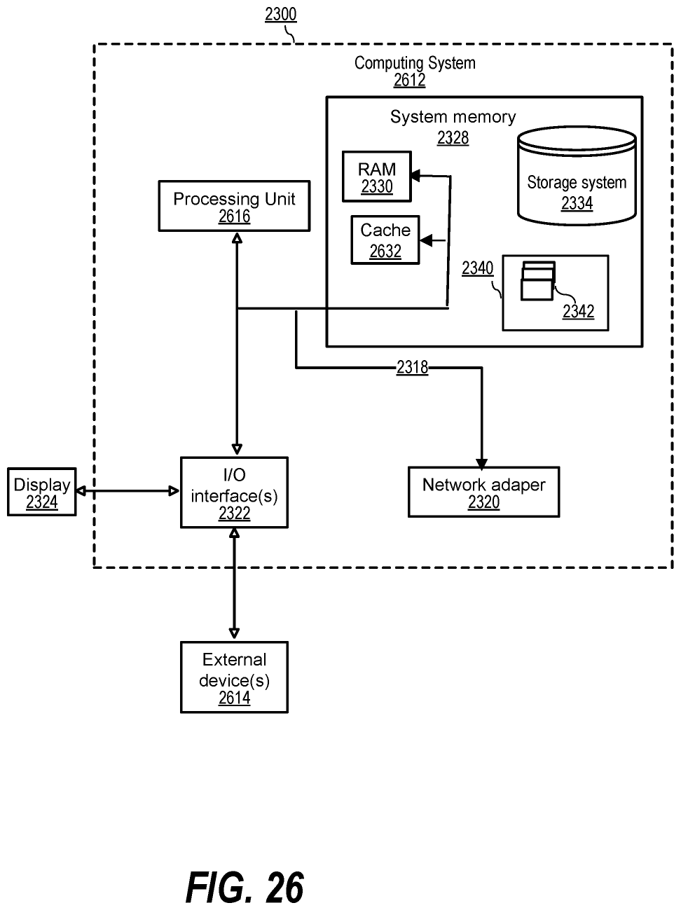

Referring to FIG. 26, a schematic view of a processing system 2600 is shown wherein the methods of this invention may be implemented. The processing system 2600 is only one example of a suitable system and is not intended to suggest any limitation as to the scope of use or functionality of embodiments of the invention described herein. Regardless, the system 2600 can implement and/or performing any of the functionality set forth herein. In the system 2600 there is a computer system 2612, which is operational with numerous other general purpose or special purpose computing system environments or configurations. Examples of well-known computing systems, environments, and/or configurations that may be suitable for use with the computer system 2612 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system 2612 may be described in the general context of computer system-executable instructions, such as program modules, being executed by a computer system. Generally, program modules may include routines, programs, objects, components, logic, data structures, and so on that perform tasks or implement abstract data types. The computer system 2612 may be practiced in distributed cloud computing environments where tasks are performed by remote processing devices that are linked through a communications network. In a distributed cloud computing environment, program modules may be in both local and remote computer system storage media including memory storage devices.

As shown in FIG. 26, the computer system 2612 in the system environment 2600 is shown in the form of a general-purpose computing device. The components of the computer system 2612 may include, but are not limited to, a set of one or more processors or processing units 2616, a system memory 2628, and a bus 2618 that couples various system components including the system memory 2628 to the processor 2616.

The bus 2618 represents one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA) bus, the Micro Channel Architecture (MCA) bus, the Enhanced ISA (EISA) bus, the Video Electronics Standards Association (VESA) local bus, and the Peripheral Component Interconnects (PCI) bus.

The computer system 2612 typically includes a variety of computer system readable media. Such media may be any available media that is accessible by the computer system 2612, and it includes both volatile and non-volatile media, removable and non-removable media.

The system memory 2628 can include computer system readable media in the form of volatile memory, such as random-access memory (RAM) 2630 and/or a cache memory 2632. The computer system 2612 may further include other removable/non-removable, volatile/non-volatile computer system storage media. By way of example only, a storage system 2634 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 2618 by one or more data media interfaces. As will be further depicted and described below, the system memory 2628 may include at least one program product having a set (e.g., at least one) of program modules 2642 that are configured to carry out the functions of embodiments of the invention.

A program/utility 2640, having the set (at least one) of program modules 2642, may be stored in the system memory 2628 by way of example, and not limitation, as well as an operating system, one or more application programs, other program modules, and program data. Each of the operating systems may have one or more application programs, other program modules, and program data or some combination thereof, and may include an implementation of a networking environment. The program modules 2642 generally carry out the functions and/or methodologies of embodiments of the invention as described herein.

The computer system 2612 may also communicate with a set of one or more external devices 2614 such as a keyboard, a pointing device, a display 2624, a tablet, a digital pen, etc. wherein these one or more devices enable a user to interact with the computer system 2612; and/or any devices (e.g., network card, modem, etc.) that enable the computer system 2612 to communicate with one or more other computing devices. Such communication can occur via Input/Output (I/O) interfaces 2622. These include wireless devices and other devices that may be connected to the computer system 2612, such as, a USB port, which may be used by a tablet device (not shown). Still yet, the computer system 2612 can communicate with one or more networks such as a local area network (LAN), a general wide area network (WAN), and/or a public network (e.g., the Internet) via a network adapter 2620. As depicted, a network adapter 2620 communicates with the other components of the computer system 2612 via the bus 2618. It should be understood that although not shown, other hardware and/or software components could be used in conjunction with the computer system 2612. Examples include, but are not limited to microcode, device drivers, redundant processing units, external disk drive arrays, RAID systems, tape drives, and data archival storage systems, etc.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method that includes a processor and a local storage device accessible by the processor for numerically delineated value transfer comprising:
providing an infrastructure for representation of values for the numerically delineated value transfer that minimizes real-time operations to transfer a first value in a first representation of the first value to a second value in a second represent representation of the second value and wherein the infrastructure supports recovery from operational failures;
responsive to receiving by the infrastructure an operation with a recovery indication and an indication of the first representation, performing the operation wherein the operation is one of a split operation and a combine operation and wherein for the split operation an amount to split is specified and the first value in the first representation is decremented by the amount to split and the amount to split is included in the second representation and wherein for the combine operation the first representation contains the first value to be added to the second value in the second representation and wherein the infrastructure extracts the first value from the first representation and prevents access to the first representation prior to adding the first value to the second representation.

2. The method of claim 1, wherein the split operation further comprises:
verifying the amount to split is available in the first representation; and
failing the operation if the amount to split is not available in the first representation.

3. The method of claim 1, further comprising:
failing the split operation when an absence the first representation is detected.

4. The method of claim 1, wherein the combine operation further comprises:
providing an application programming interface (API) supporting an input of the first representation with an absence of the second representation; and
responsive to detecting the absence of the second representation, by the API, creating a new representation for the second representation.

5. The method of claim 1, wherein a transaction fee is deducted from the first value.

6. The method of claim 1, wherein the first representation is a first data structure, and the second representation is a second data structure.

7. The method of claim 6, wherein the first data structure is a first block with a first block id, a first delineated value id, and a first value, and wherein the second data structure is a second block with a second block id, a second delineated value id, and a second value.

8. The method of claim 6, wherein the infrastructure includes a split operation that takes as input a recovery aid, the first block, and a value to split from the first block and outputs the second block.

9. The method of claim 1, further comprising:
recording each operation affecting a value in the representation of values to a rotating real-time log; and
copying the real-time log to storage media.

10. The method of claim 9, wherein the recording further comprises:
a recovery aid, a transaction id, an indication of the data structure, and a value.

11. The method of claim 1, further comprising:
collecting the representation of values in a wallet wherein the wallet is a user interface (UI) supporting operations to and from the wallet; and
responsive to a user utilizing the UI by identifying an operation to be applied to the wallet, applying the operation to the wallet.

12. The method of claim 11, wherein the supporting operations further comprises:
adding, splitting, combining, and trading entries to the wallet.

13. The method of claim 11, wherein the UI does not require a user login.

14. The method of claim 13, further comprising:
allowing a first user to utilize the UI to trade a first representation of a value in a first wallet with a second representation of a value in a second wallet.

15. An information handling system for numerically delineated value transfer comprising:
one or more processors;
a memory coupled to at least one of the processors;
a network interface that connects the local device to one or more remote web sites; and
a set of computer program instructions stored in the memory and executed by at least one of the processors in order to perform actions comprising:
providing an infrastructure for representation of values for the numerically delineated value transfer that minimizes real-time operations to transfer a first value in a first representation of the first value to a second value in a second represent representation of the second value and wherein the infrastructure supports recovery from operational failures;
responsive to receiving by the infrastructure an operation with a recovery indication and an indication of the first representation, performing the operation wherein the operation is one of a split operation and a combine operation and wherein for the split operation an amount to split is specified and the first value in the first representation is decremented by the amount to split and the amount to split is included in the second representation and wherein for the combine operation the first representation contains the first value to be added to the second value in the second representation and wherein the infrastructure extracts the first value from the first representation and prevents access to the first representation prior to adding the first value to the second representation.

16. The information handling system of claim 15, wherein the split operation further comprises:
verifying the amount to split is available in the first representation; and
failing the operation if the amount to split is not available in the first representation.

17. The information handling system of claim 15, further comprising:
failing the split operation when an absence the first representation is detected.

18. A computer program product for numerically delineated value transfer comprising stored in a computer readable storage medium, comprising computer program code that, when executed by the computer program product, performs actions comprising:
providing an infrastructure for representation of values for the numerically delineated value transfer that minimizes real-time operations to transfer a first value in a first representation of the first value to a second value in a second represent representation of the second value and wherein the infrastructure supports recovery from operational failures;
responsive to receiving by the infrastructure an operation with a recovery indication and an indication of the first representation, performing the operation wherein the operation is one of a split operation and a combine operation and wherein for the split operation an amount to split is specified and the first value in the first representation is decremented by the amount to split and the amount to split is included in the second representation and wherein for the combine operation the first representation contains the first value to be added to the second value in the second representation and wherein the infrastructure extracts the first value from the first representation and prevents access to the first representation prior to adding the first value to the second representation.

19. The computer program product of claim 18, wherein the split operation further comprises:
verifying the amount to split is available in the first representation; and
failing the operation if the amount to split is not available in the first representation.

20. The computer program product of claim 18, further comprising:
failing the split operation when an absence of the first representation is detected.
